(19) United States
(12) Patent Application Publication
(10) Pub. No.: US 2026/0062507 A1
(43) Pub. Date: Mar. 5, 2026

(54) PHOSPHORUS-CONTAINING POLYMER, RESIN COMPOSITION AND ARTICLE MADE THEREFROM

(71) Applicant: Elite Electronic Material (KunShan) Co., Ltd., Kunshan City (CN)

(72) Inventors: Xingxing YAO, Kunshan City (CN); Rongtao WANG, Kunshan City (CN); Chengsong LIU, Kunshan City (CN); Yiqiang GE, Kunshan City (CN)

(21) Appl. No.: 18/920,226

(22) Filed: Oct. 18, 2024

(30) Foreign Application Priority Data
Sep. 2, 2024 (CN) 202411223194.1

(51) Int. Cl. C08F 230/02; C08F 212/32; C08J 5/24; C08L 43/02; C08L 71/12

(52) U.S. Cl. CPC C08F 230/02; C08F 212/32; C08J 5/244; C08L 43/02; C08L 71/123; C08F 2800/20; C08J 2343/02; C08J 2371/12; C08J 2443/02; C08J 2471/12; C08L 2201/02

(57) ABSTRACT

A phosphorus-containing polymer includes a structural unit derived from a first monomer and a structural unit derived from a second monomer. A resin composition contains the phosphorus-containing polymer, and an article is made from the resin composition. The resin composition includes: 100 parts by weight of a free radical polymerizable resin, the free radical polymerizable resin including an unsaturated C═C double bond-containing polyphenylene ether resin, a maleimide resin, a polyolefin or a combination thereof; and 12 parts by weight to 100 parts by weight of the phosphorus-containing polymer. The resin composition or the article made therefrom may achieve improvements in one or more properties including glass transition temperature, flame retardancy, dissipation factor, peeling strength, percent of thermal expansion in Z-axis, laminate appearance, heat resistance after moisture absorption and multi-layer board heat resistance.

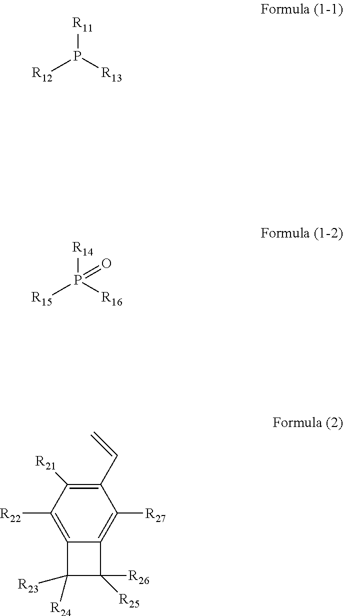

### CROSS-REFERENCE TO RELATED APPLICATION

This application claims the priority benefits of China Patent Application No. 2024112231941, filed on Sep. 2, 2024. The entirety of the above-mentioned patent application is hereby incorporated by reference herein and made a part of this specification.

### BACKGROUND

### 1. Field of the Disclosure

The present disclosure mainly relates to a phosphorus-containing polymer, a resin composition comprising the same and an article made from the resin composition, more particularly to a phosphorus-containing polymer and a resin composition containing the same useful for preparing a prepreg, a resin film, a metal-clad laminate and a printed circuit board.

### 2. Description of Related Art

Among resin materials used for a prepreg, a resin film, a metal-clad laminate and a printed circuit board (PCB), it is increasingly becoming a trend to use an environmentally friendly phosphorus-based flame retardant to improve the flame retardancy of the materials. However, most of the currently commercially available phosphorus-based flame retardants, on the one hand, are additive non-reactive flame retardants, typical examples of the flame retardants including an aromatic condensed phosphate ester flame retardant and a DOPO flame retardant. The former has a lower melting point, which will cause serious deterioration in the glass transition temperature and dimensional stability of the resin material. The latter has a higher melting point but poorer solubility and is not uniformly dispersed in the resin material, making it difficult to process and causing non-uniform laminate appearance. On the other hand, existing reactive flame retardants, such as allyl group-containing phosphazene compounds, usually lead to problems including poor dielectric properties of articles (increased dielectric constant and dissipation factor) and poor copper foil peeling strength, etc. In addition, the industry has also presented more challenges to the heat resistance of metal-clad laminates, such as property demands including heat resistance after moisture absorption and multi-layer board heat resistance.

### SUMMARY

To overcome the problems facing prior arts, particularly one or more of the above-mentioned technical problems of conventional materials, it is a primary object of the present disclosure to provide a phosphorus-containing polymer, a resin composition comprising the same and an article made from the resin composition which may overcome at least one of the above-mentioned technical problems. More specifically, the primary object of the present disclosure is to provide a phosphorus-containing polymer, which may be used as a reactive phosphorus-based flame retardant; an article made from the resin composition comprising the same has one, more or all properties including higher glass transition temperature, better flame retardancy, higher peeling strength, higher heat resistance after moisture absorption, higher multi-layer board heat resistance, lower dissipation factor, lower percent of thermal expansion in Z-axis and more uniform laminate appearance.

To achieve the above-mentioned object, the present disclosure provides a phosphorus-containing polymer, comprising a structural unit derived from a first monomer and a structural unit derived from a second monomer, the first monomer comprising a phosphorus-containing compound of Formula (1-1), a phosphorus-containing compound of Formula (1-2) or a combination thereof, and the second monomer comprising a compound of Formula (2),

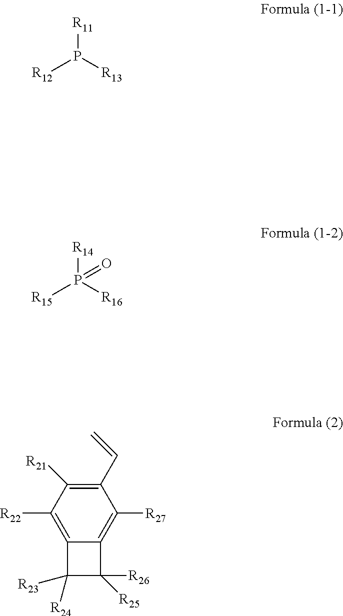

wherein:
in Formula (1-1), R₁₁ is a C2 to C4 alkenyl group or a C2 to C4 alkenyl group-substituted phenyl group, R₁₂ and R₁₃ each independently is a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group; in Formula (1-2), R₁₄ is a C2 to C4 alkenyl group or a C2 to C4 alkenyl group-substituted phenyl group, R₁₅ and R₁₆ each independently is a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group; in Formula (2), R₂₁ to R₂₇ each independently is a C1 to C3 hydrocarbyl group or a hydrogen atom; and the phosphorus-containing polymer does not comprise a structural unit derived from styrene.

For example, in one embodiment, the phosphorus-containing polymer has a phosphorus content of between 2.2 wt % and 8.5 wt %. For example, in another embodiment, the phosphorus-containing polymer has a phosphorus content of between 3.0 wt % and 8.0 wt %.

For example, in one embodiment, the first monomer comprises a phosphorus-containing compound of any one of Formula (1.1) to Formula (1.12) or a combination thereof:

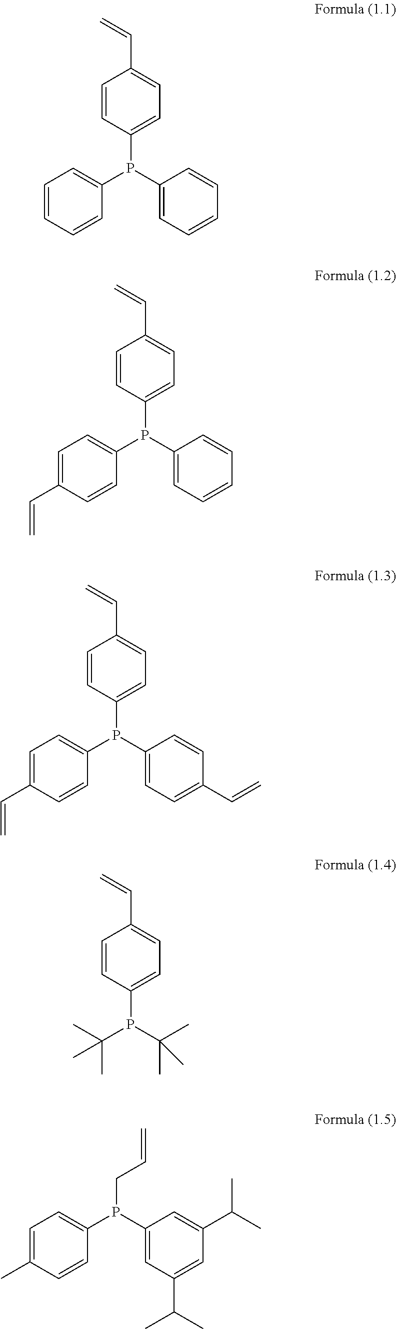

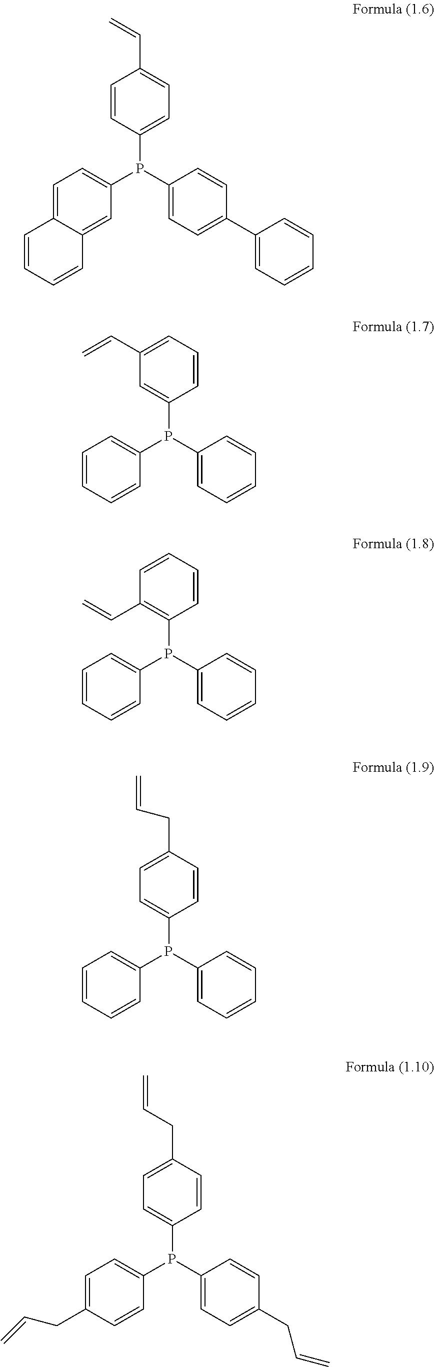 [SMILES: C=Cc1ccc(P(c2ccc(-c3ccccc3)cc2)c2ccc3ccccc3c2)cc1 ; C=Cc1cccc(P(c2ccccc2)c2ccccc2)c1 ; C=Cc1ccccc1P(c1ccccc1)c1ccccc1 ; C=CCc1ccc(P(c2ccccc2)c2ccccc2)cc1 ; C=CCc1ccc(P(c2ccc(CC=C)cc2)c2ccc(CC=C)cc2)cc1]

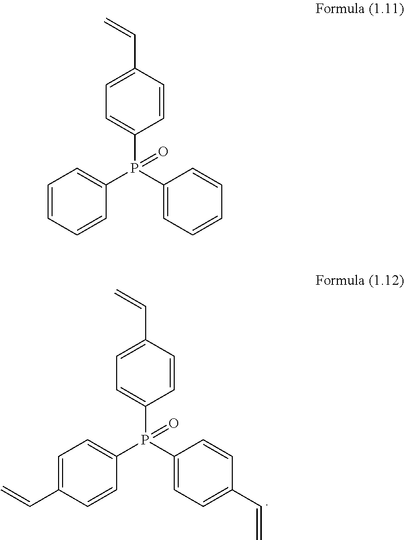 [SMILES: C=Cc1ccc(P(=O)(c2ccccc2)c2ccccc2)cc1 ; C=Cc1ccc(P(=O)(c2ccc(C=C)cc2)c2ccc(C=C)cc2)cc1]

For example, in one embodiment, the second monomer comprises a compound of any one of Formula (2.1) to Formula (2.3) or a combination thereof:

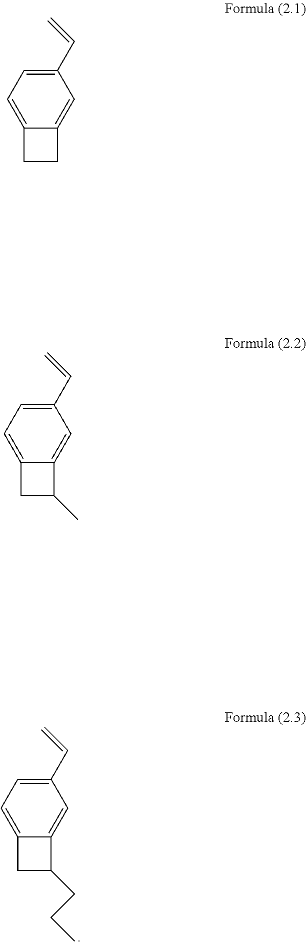

For example, in one embodiment, the phosphorus-containing polymer has a structure of any one of Formula (P-1) to Formula (P-14):

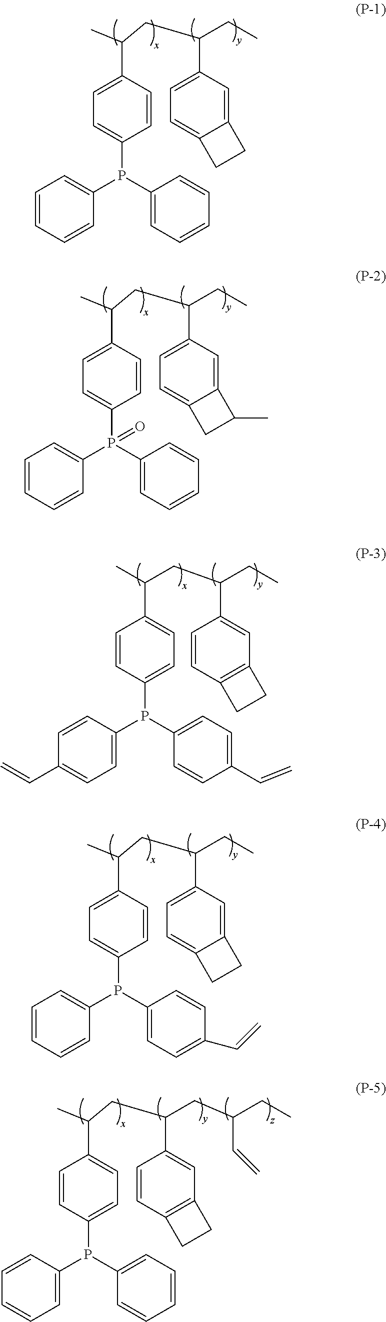

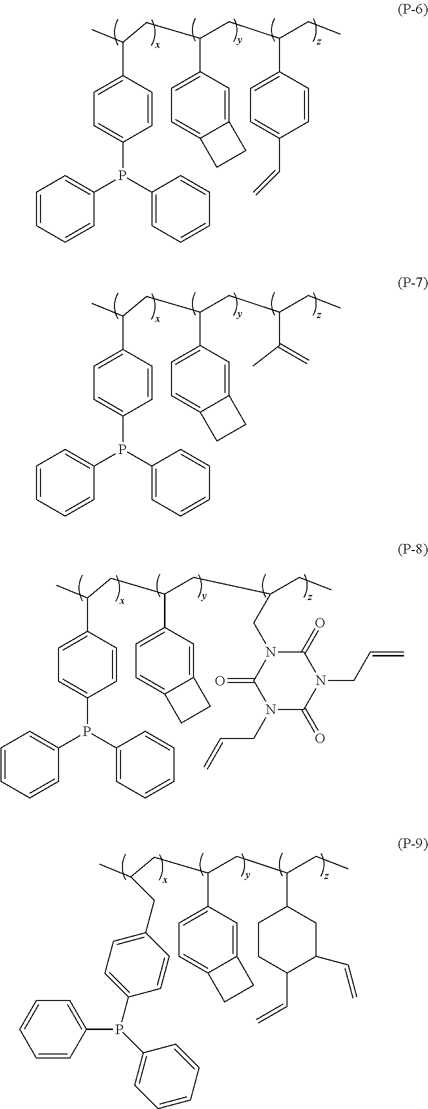

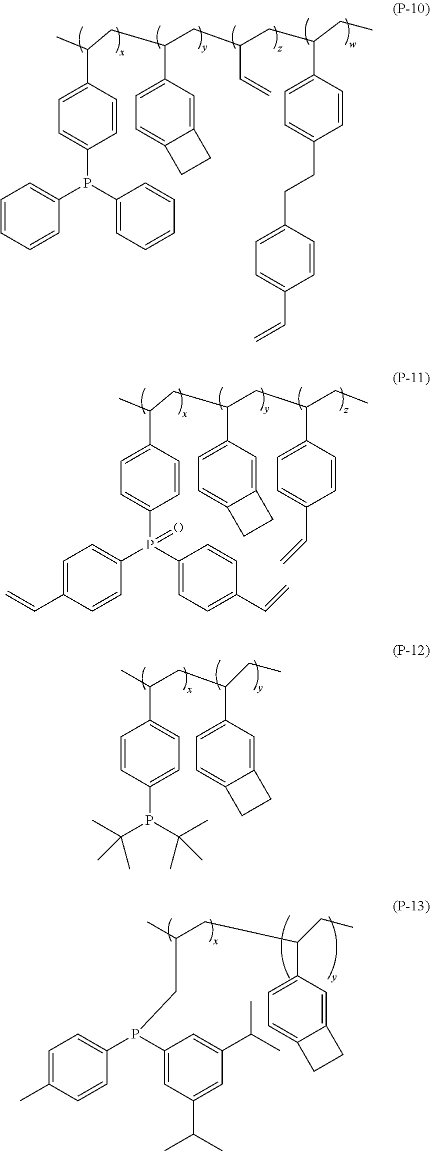

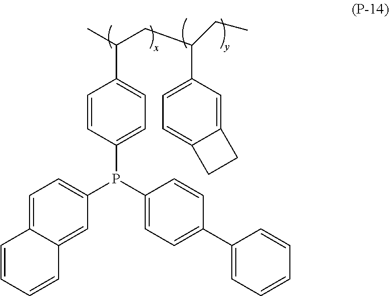

wherein x, y, z and w represent an average number of repeating units, and x is 0.10 to 28.00, y is 0.01 to 64.00, z is 0.01 to 27.00 and w is 0.01 to 5.00.

For example, in one embodiment, the phosphorus-containing polymer further comprises a structural unit derived from the following monomer: butadiene, isoprene, decadiene, octadiene, bis(vinylphenyl) ethane, divinylbenzene, divinylnaphthalene, divinylbiphenyl, triallyl isocyanurate, triallyl cyanurate, bis(vinylbenzyl) ether, trivinyl cyclohexane or a combination thereof.

In another aspect, the present disclosure further provides a resin composition including the aforesaid phosphorus-containing polymer, comprising 100 parts by weight of a free radical polymerizable resin, the free radical polymerizable resin comprising an unsaturated C═C double bond-containing polyphenylene ether resin, a maleimide resin, a polyolefin or a combination thereof; and 12 parts by weight to 100 parts by weight of the phosphorus-containing polymer.

For example, in one embodiment, the resin composition comprises 20 parts by weight to 100 parts by weight of the phosphorus-containing polymer.

For example, in one embodiment, the resin composition further comprises an unsaturated C═C double bond-containing crosslinking agent, a benzoxazine resin, an epoxy resin, a polyester resin, a phenolic resin, an amine curing agent, a polyamide, a polyimide, a styrene maleic anhydride, a cyanate ester, a maleimide triazine resin or a combination thereof.

For example, in one embodiment, the resin composition further comprises a flame retardant different from the phosphorus-containing polymer, a curing accelerator, a polymerization inhibitor, an inorganic filler, a solvent, a silane coupling agent, a surfactant, a coloring agent, a toughening agent or a combination thereof.

In another aspect, the present disclosure also provides an article made from the aforesaid resin composition. For example, in one embodiment, the article comprises a prepreg, a resin film, a metal-clad laminate or a printed circuit board. For example, in another embodiment, the article comprises a cured product obtained by curing the resin composition.

For example, in one embodiment, the article described above has at least one, more or all of the following properties:
a glass transition temperature as measured by reference to IPC-TM-650 2.4.24.4 of greater than or equal to 205° C.;
a flame retardancy of V0 rating as measured by reference to UL94;
a dissipation factor as measured by reference to JIS C2565 of less than or equal to 0.00235;
a peeling strength as measured by reference to IPC-TM-650 2.4.8 of greater than or equal to 3.5 lb/in;
a percent of thermal expansion in Z-axis as measured by reference to IPC-TM-650 2.4.24.5 of less than or equal to 1.8%;
no delamination in a heat resistance test after moisture absorption as measured by reference to IPC-TM-650 2.6.16.1 and IPC-TM-650 2.4.23;
article appearance being absent from non-uniform resin flow; and
no delamination in a multi-layer board heat resistance test.

### BRIEF DESCRIPTION OF THE DRAWINGS

The sole FIGURE illustrates the gel permeation chromatography (GPC) analysis results of the phosphorus-containing polymer A2.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “encompasses,” “encompassing,” “comprises,” “comprising,” “includes,” “including,” “has,” “having” or any other variant thereof is construed as an open-ended transitional phrase intended to cover a non-exclusive inclusion. For example, a composition comprising a list of elements or an article made therefrom encompasses any one or any type of the listed elements and is not necessarily limited to only those elements listed herein, but may also include other elements not expressly listed or inherent to such composition or article. Further, unless expressly stated to the contrary, the term “or” refers to an inclusive or and not to an exclusive or. For example, a condition “A or B” is satisfied by any one of the following: A is true (or present) and B is false (or not present), A is false (or not present) and B is true (or present), and both A and B are true (or present). In addition, whenever open-ended transitional phrases are used, such as “encompasses,” “encompassing,” “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

As used herein, “or a combination thereof” means “or any combination thereof” encompasses any combination of two or more of the listed elements, and “any” means “any one”, vice versa. For example, a composition or an article made therefrom “includes A, B, C or a combination thereof” or a composition or an article made therefrom “includes any one of A, B and C or a combination thereof” is construed to encompass the following situations: A is true (or present), and B and C are false (or not present); B is true (or present), and A and C are false (or not present); C is true (or present), and A and B are false (or not present); A and B are true (or present), and C is false (or not present); A and C are true (or present), and B is false (or not present); B and C are true (or present), and A is false (or not present); A, B and C are all true (or present), and other elements not expressly listed but inherent to such composition or article.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features and conditions such as values, numbers, contents, amounts or concentrations are presented as a numerical range or a percentage range merely for convenience and brevity. Therefore, a numerical range or a percentage range should be interpreted as encompassing and specifically disclosing all possible subranges and individual numerals or values therein, including integers and fractions, particularly all integers therein. For example, a range of “1.0 to 8.0” or “between 1.0 and 8.0” should be understood as explicitly disclosing all subranges such as 1.0 to 8.0, 1.0 to 7.0, 2.0 to 8.0, 2.0 to 6.0, 3.0 to 6.0, 4.0 to 8.0, 3.0 to 8.0 and so on and encompassing the endpoint values, particularly subranges defined by integers, as well as disclosing all individual values in the range such as 1.0, 2.0, 3.0, 4.0, 5.0, 6.0, 7.0 and 8.0. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X₁, X₂ and X₃,” it is intended to disclose the situations of X is X₁ and X is X₁ and/or X₂ and/or X₃. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X₁, X₂ and X₃” and Y is described as being “selected from a group consisting of Y₁, Y₂ and Y₃,” the disclosure encompasses any combination of X is X₁ and/or X₂ and/or X₃ and Y is Y₁ and/or Y₂ and/or Y₃.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A homopolymer refers to the polymer formed by the polymerization of one monomer. A copolymer refers to the polymer formed by the polymerization of two or more different monomers. Copolymers comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. For example, a styrene-butadiene copolymer disclosed herein is interpreted as comprising a styrene-butadiene random copolymer, a styrene-butadiene alternating copolymer, a styrene-butadiene graft copolymer or a styrene-butadiene block copolymer. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured. The term “polymer” includes but is not limited to an oligomer. An oligomer refers to a polymer with 2 to 20, typically 2 to 5, repeating units.

To those of ordinary skill in the art to which this disclosure pertains, a resin composition containing an additive and three compounds (e.g., A, B and C), a total of four components, is different from a resin composition containing the additive and a prepolymer formed by the three compounds (e.g., A, B and C), a total of two components, as they are completely different from each other in the aspects of preparation method, physical or chemical properties of the resin composition and properties of an article or product made therefrom. For example, the former involves mixing A, B, C and the additive to form the resin composition; in contrast, the latter involves first subjecting a mixture comprising A, B and C to a prepolymerization reaction at proper conditions to form a prepolymer and then mixing the prepolymer with the additive to form the resin composition. For example, to those of ordinary skill in the art to which this disclosure pertains, the two resin compositions have completely different compositions; in addition, because the prepolymer formed by A, B and C functions completely different from A, B and C individually or collectively in the resin composition, the two resin compositions should be construed as completely different chemical substances and have completely different chemical statuses. For example, to those of ordinary skill in the art to which this disclosure pertains, because the two resin compositions are completely different chemical substances, articles made therefrom will not have the same properties. For example, to a resin composition containing a crosslinking agent and a prepolymer formed by A, B and C, since A, B and C have been partially reacted or converted during the prepolymerization reaction to form the prepolymer, during the process of heating to semi-cure the resin composition at a high temperature condition, a partial crosslinking reaction occurs between the prepolymer and the crosslinking agent but not between A, B and C individually and the crosslinking agent. As such, articles made from the two resin compositions will be completely different and have completely different properties.

Unless otherwise specified, the term “resin” of the present disclosure is a widely used common name of a synthetic polymer and is construed as comprising monomer and its combination, polymer and its combination or a combination of monomer and its polymer, but not limited thereto.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from copolymerizing a resin and other resins, etc.

The unsaturated bond described herein, unless otherwise specified, refers to a reactive unsaturated bond, such as but not limited to an unsaturated double bond with the potential of being crosslinked with other functional groups, such as an unsaturated C═C double bond with the potential of being crosslinked with other functional groups, but not limited thereto.

The unsaturated C═C double bond as used herein preferably comprises, but not limited to, a vinyl group, a vinylbenzyl group, a (meth)acryloyl group, an allyl group or a combination thereof. The term “vinyl group” is construed as comprising a vinyl group and a vinylene group, and the term “(meth)acryloyl group” is construed as comprising an acryloyl group and a methacryloyl group.

The hydrocarbyl group described herein is construed as comprising a saturated or an unsaturated hydrocarbyl group, such as an alkyl group, an alkenyl group and an alkynyl group.

Unless otherwise specified, the functional group described herein, such as but not limited to an alkyl group, an alkenyl group and an alkynyl group, is construed to encompass various isomers thereof. For example, a propyl group is construed to encompass n-propyl and iso-propyl. The compounds described herein are construed to encompass various isomers thereof, such as compounds with the same molecular formula but with different substitution positions of a substituent.

Unless otherwise specified, as used herein, part(s) by weight represents weight part(s) in any weight unit in the resin composition, such as but not limited to kilogram, gram, pound and so on. For example, 100 parts by weight of an unsaturated C═C double bond-containing polyphenylene ether resin may represent 100 kilograms of the unsaturated C═C double bond-containing polyphenylene ether resin or 100 pounds of the unsaturated C═C double bond-containing polyphenylene ether resin; for example, 100 parts by weight of a maleimide resin may represent 100 kilograms of the maleimide resin or 100 grams of the maleimide resin; and for example, 100 parts by weight of a polyolefin may represent 100 pounds of the polyolefin or 100 grams of the polyolefin.

Unless otherwise specified, in the present disclosure, wt % represents weight (or mass) percentage.

It should be understood that all features disclosed herein may be combined in any way to constitute the technical solution of the present disclosure, as long as there is no conflict present in the combination of these features.

Examples and embodiments are described in detail below. It will be understood that these examples and embodiments are exemplary only and are not intended to limit the scope and use of the present disclosure. Unless otherwise specified, processes, reagents and conditions described in the examples are those known in the art.

As described above, the present disclosure mainly provides a phosphorus-containing polymer (i.e., phosphorus-containing copolymer), which may be obtained by polymerizing a monomer composition, and the monomer composition at least contains a first monomer and a second monomer but not contains a styrene monomer. Unless otherwise specified, the monomer composition may also optionally comprise a third monomer, a fourth monomer, etc., but not limited thereto.

The phosphorus-containing polymer of the present disclosure comprises a structural unit derived from a first monomer and a structural unit derived from a second monomer, the first monomer comprising a phosphorus-containing compound of Formula (1-1), a phosphorus-containing compound of Formula (1-2) or a combination thereof, and the second monomer comprising a compound of Formula (2),

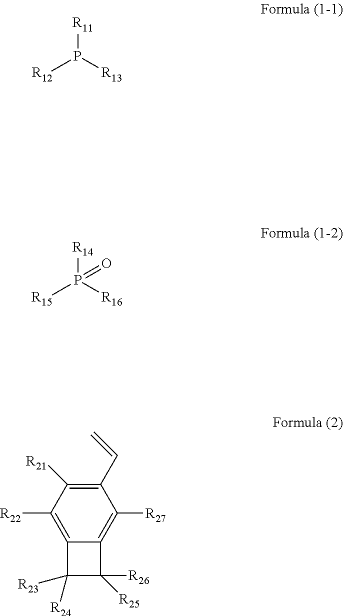

wherein:
in Formula (1-1), R₁₁ is a C2 to C4 alkenyl group (such as but not limited to vinyl, propenyl, allyl and various isomers of butenyl) or a C2 to C4 alkenyl group-substituted phenyl group, R₁₂ and R₁₃ each independently is a C1 to C4 alkyl group (such as but not limited to methyl, ethyl, n-propyl, isopropyl and various isomers of butyl), a C2 to C4 alkenyl group, a phenyl group, a C1 to C4 alkyl group-substituted phenyl group, a C2 to C4 alkenyl group-substituted phenyl group, a biphenyl group or a naphthyl group;
in Formula (1-2), R₁₄ is a C2 to C4 alkenyl group or a C2 to C4 alkenyl group-substituted phenyl group, R₁₅ and R₁₆ each independently is a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group; in Formula (2), R₂₁ to R₂₇ each independently is a C1 to C3 hydrocarbyl group or a hydrogen atom; and
the phosphorus-containing polymer does not comprise a structural unit derived from styrene.

For example, in a preferred embodiment, R₁₁ is a C2 to C4 alkenyl group-substituted phenyl group, R₁₂ and R₁₃ each independently is a phenyl group, a C1 to C4 alkyl group-substituted phenyl group or a C2 to C4 alkenyl group-substituted phenyl group, R₁₄ is a C2 to C4 alkenyl group-substituted phenyl group, R₁₅ and R₁₆ each independently is a phenyl group, a C1 to C4 alkyl group-substituted phenyl group or a C2 to C4 alkenyl group-substituted phenyl group.

For example, the monomer composition containing at least a first monomer and a second monomer may be subjected to a polymerization reaction to obtain the phosphorus-containing polymer of the present disclosure. For example, in one embodiment, the polymerization reaction can be performed under high temperature conditions, such as but not limited to a polymerization reaction performed at a temperature of 100° C. to 150° C. for 0.5 to 5 hours. For example, in one embodiment, the polymerization reaction can be performed in the presence of a curing accelerator, and the type of the curing accelerator is not particularly limited. The curing accelerator suitable for the resin composition of the present disclosure can be used for the polymerization reaction, and examples are described below.

According to the present disclosure, the phosphorus content of the phosphorus-containing polymer is not particularly limited. For example, in one embodiment, the phosphorus-containing polymer has a phosphorus content of between 2.2 wt % and 8.5 wt %. For example, in another embodiment, the phosphorus-containing polymer has a phosphorus content of between 3.0 wt % and 8.0 wt %. The phosphorus content of the phosphorus-containing polymer can be calculated by those with ordinary skill in the art based on the structure and content of the phosphorus-containing monomer (such as the first monomer). The phosphorus content can also be measured by known methods, such as but not limited to various methods known in the art including spectrophotometry and inductively coupled plasma emission spectroscopy.

According to the present disclosure, the molecular weight of the phosphorus-containing polymer is not particularly limited. For example, in one embodiment, the phosphorus-containing polymer has a weight average molecular weight of 150 to 10,000 g/mol. The molecular weight of the phosphorus-containing polymer can be measured and calculated by those with ordinary skill in the art using known methods, such as but not limited to gel permeation chromatography (GPC).

For example, in one embodiment, the first monomer may comprise the aforementioned phosphorus-containing compound of any one of Formula (1.1) to Formula (1.12) or a combination thereof, but not limited thereto. For example, in one embodiment, the second monomer may comprise the aforementioned compound of any one of Formula (2.1) to Formula (2.3) or a combination thereof, but not limited thereto.

In addition to the first monomer and the second monomer, in one embodiment, the phosphorus-containing polymer of the present disclosure also comprises a structural unit derived from other monomers; examples of other monomers include but are not limited to: butadiene, isoprene, decadiene, octadiene, bis(vinylphenyl) ethane, divinylbenzene, divinylnaphthalene, divinylbiphenyl, triallyl isocyanurate, triallyl cyanurate, bis(vinylbenzyl) ether, trivinyl cyclohexane or a combination thereof. Unless otherwise specified, the other monomers described above may be used as a third monomer, a fourth monomer, etc., but not limited thereto. For example, in one embodiment, the total content of the other monomers is less than or equal to 25 wt %. For example, when a third monomer is contained, the content of the third monomer is less than or equal to 25 wt %, and when a third monomer and a fourth monomer are contained, the total content of the third monomer and the fourth monomer is less than or equal to 25 wt %, wherein the content of the third monomer is less than or equal to 15 wt %, and the content of the fourth monomer is less than or equal to 10 wt %, but not limited thereto.

For example, in one embodiment, the phosphorus-containing polymer of the present disclosure may have the structure of any one of Formula (P-1) to Formula (P-14), but not limited thereto, wherein x, y, z and w represent an average number of repeating units, which can be calculated based on the weight average molecular weight of the phosphorus-containing polymer (such as 150 to 10,000 g/mol) and the phosphorus content (such as 2.2 wt % to 8.5 wt %). For example, x is 0.10 to 28.00, y is 0.01 to 64.00, z is 0.01 to 27.00 and w is 0.01 to 5.00. It should be noted that Formula (P-1) to Formula (P-14) only illustrate that the phosphorus-containing polymer has x, y, z, or w structural units, but the specific bonding order of each structural unit is not limited. In other words, each structural unit can be bonded in various forms, including but not limited to random bonding, alternating bonding or block bonding.

On the other hand, the present disclosure also provides a resin composition, which comprises:
(1) 100 parts by weight of a free radical polymerizable resin, the free radical polymerizable resin comprising an unsaturated C═C double bond-containing polyphenylene ether resin, a maleimide resin, a polyolefin or a combination thereof; and
(2) 12 parts by weight to 100 parts by weight of the phosphorus-containing polymer.

In the resin composition of the present disclosure, relative to 100 parts by weight of the free radical polymerizable resin, the type of the phosphorus-containing polymer may be one or more, and the total amount of the phosphorus-containing polymer may be 12 parts by weight to 100 parts by weight, such as but not limited to 12 parts by weight, 15 parts by weight, 20 parts by weight, 30 parts by weight, 35 parts by weight, 40 parts by weight, 50 parts by weight, 60 parts by weight, 70 parts by weight, 80 parts by weight, 90 parts by weight or 100 parts by weight of a phosphorus-containing polymer.

For example, in one embodiment, the resin composition of the present disclosure preferably comprises 100 parts by weight of a free radical polymerizable resin and 20 parts by weight to 100 parts by weight of the phosphorus-containing polymer.

The unsaturated C═C double bond-containing polyphenylene ether resin suitable for the present disclosure is not particularly limited and may be any one or more unsaturated C═C double bond-containing polyphenylene ether resins useful for making a prepreg, a resin film, a metal-clad laminate or a printed circuit board and may be any one or more commercial products, products prepared by the Applicant or a combination thereof, examples including but not limited to any one of a vinylbenzyl group-containing polyphenylene ether resin, a (meth)acryloyl group-containing polyphenylene ether resin, a vinyl group-containing polyphenylene ether resin, an allyl group-containing polyphenylene ether resin or a combination thereof.

The unsaturated C═C double bond-containing polyphenylene ether resin of the present disclosure has an unsaturated C═C double bond and a phenylene ether skeleton, wherein the unsaturated C═C double bond is a reactive group which may perform self-polymerization under heat and may also perform free radical polymerization with other components with unsaturated bonds in the resin composition and finally result in crosslinking and curing. The cured product thereof has high heat resistance and good dielectric properties. Preferably, the unsaturated C═C double bond-containing polyphenylene ether resin comprises an unsaturated C═C double bond-containing polyphenylene ether resin with 2,6-dimethyl substitution in its phenylene ether skeleton, wherein the methyl groups form steric hindrance to prevent the oxygen atom of the ether group from forming a hydrogen bond or Van der Waals force to absorb moisture, thereby achieving better dielectric properties.

For example, in one embodiment, the unsaturated C═C double bond-containing polyphenylene ether resin comprises, but not limited to, a vinylbenzyl group-containing polyphenylene ether resin with a number average molecular weight of about 1200 (such as OPE-2st 1200, available from Mitsubishi Gas Chemical Co., Inc.), a vinylbenzyl group-containing polyphenylene ether resin with a number average molecular weight of about 2200 (such as OPE-2st 2200, available from Mitsubishi Gas Chemical Co., Inc.), a vinylbenzyl group-containing polyphenylene ether resin with a number average molecular weight of about 2400 to 2800 (such as a vinylbenzyl group-containing bisphenol A polyphenylene ether resin), a (meth)acryloyl group-containing polyphenylene ether resin with a number average molecular weight of about 1900 to 2300 (such as SA9000, available from Sabic), a vinyl group-containing polyphenylene ether resin with a number average molecular weight of about 2200 to 3000, or a combination thereof. The vinyl group-containing polyphenylene ether resin may include various polyphenylene ether resins disclosed in the US Patent Application Publication No. 20160185904A1, all of which are incorporated herein by reference in their entirety. For example, in one embodiment, the vinylbenzyl group-containing polyphenylene ether resin comprises, but not limited to, a vinylbenzyl group-containing biphenyl polyphenylene ether resin, a vinylbenzyl group-containing bisphenol A polyphenylene ether resin or a combination thereof.

The maleimide resin suitable for the present disclosure may be various maleimide resins useful in the field to which this disclosure pertains. Examples include but are not limited to: 4,4′-diphenylmethane bismaleimide, polyphenylmethane maleimide (a.k.a. oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl) hexane, N-2,3-xylylmaleimide, N-2,6-xylylmaleimide, N-phenylmaleimide, vinyl benzyl maleimide (VBM), maleimide containing indane structure, maleimide containing isopropyl and m-arylene structures, maleimide containing biphenyl alkylene structure, maleimide containing aliphatic structure with 10 to 50 carbon atoms, or a combination thereof. These components should be construed as including their modifications, examples including but not limited to a prepolymer of diallyl compound and maleimide resin, a prepolymer of diamine and maleimide resin, a prepolymer of multi-functional amine and maleimide resin, a prepolymer of acid phenol compound and maleimide resin, or a combination thereof.

For example, the maleimide resin includes but is not limited to products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000, and BMI-7000H available from Daiwakasei Industry, products such as BMI-70 and BMI-80 available from K.I Chemical Industry Co., Ltd., or products such as MIR-3000 and MIR-5000 available from Nippon Kayaku.

For example, the maleimide resin containing a C10 to C50 aliphatic structure, also known as imide-extended maleimide resin, may include various imide-extended maleimide resins disclosed in the TW Patent Application Publication No. 200508284A, all of which are incorporated herein by reference in their entirety. Examples of the maleimide resin containing a C10 to C50 aliphatic structure suitable for the present disclosure include, but not limited to, products such as BMI-689, BMI-1400, BMI-1500, BMI-1700, BMI-2500, BMI-3000, BMI-5000 and BMI-6000 available from Designer Molecules Inc.

Examples of the polyolefin suitable for the present disclosure include but are not limited to a diene polymer, a monoene polymer, a hydrogenated diene polymer or a combination thereof. The diene refers to a hydrocarbon compound containing two unsaturated C═C double bonds in the molecule, and the monoene refers to a hydrocarbon compound containing one unsaturated C═C double bond in the molecule. The polyolefin suitable for the resin composition of the present disclosure comprises, such as but not limited to, any one of polybutadiene, polyisoprene, styrene-butadiene copolymer, styrene-isoprene copolymer, styrene-butadiene-divinylbenzene polymer, maleic anhydride-adducted styrene-butadiene polymer, vinyl-polybutadiene-urethane polymer, maleic anhydride-adducted polybutadiene, polymethylstyrene, hydrogenated polybutadiene, hydrogenated polyisoprene, hydrogenated styrene-butadiene-divinylbenzene polymer, hydrogenated maleic anhydride-adducted styrene-butadiene polymer, hydrogenated styrene-butadiene copolymer, hydrogenated styrene-isoprene copolymer, divinylbenzene-styrene-ethylstyrene copolymer, divinylbenzene-styrene-vinyl terpolymer, or a combination thereof.

For example, unless otherwise specified, the divinylbenzene-styrene-ethylstyrene copolymer may include various divinylbenzene-styrene-ethylstyrene copolymers disclosed in the US Patent Application Publication No. 20070129502A1, all of which are incorporated herein by reference in their entirety.

For example, in one embodiment, the resin composition of the present disclosure may further comprise an unsaturated C═C double bond-containing crosslinking agent; relative to 100 parts by weight of the free radical polymerizable resin, the resin composition of the present disclosure may comprise 1 part by weight to 100 parts by weight of an unsaturated C═C double bond-containing crosslinking agent, preferably 18 parts by weight to 30 parts by weight of an unsaturated C═C double bond-containing crosslinking agent, such as but not limited to 18 parts by weight, 19 parts by weight, 20 parts by weight, 21 parts by weight, 22 parts by weight, 23 parts by weight, 24 parts by weight, 25 parts by weight, 26 parts by weight, 27 parts by weight, 28 parts by weight, 29 parts by weight and 30 parts by weight of an unsaturated C═C double bond-containing crosslinking agent.

The unsaturated C═C double bond-containing crosslinking agent suitable for the present disclosure refers to an unsaturated C═C double bond-containing small molecule compound with a molecular weight of less than or equal to 1000, and the molecular weight thereof is preferably between 100 and 900, more preferably between 100 and 800. For example, the unsaturated C═C double bond-containing crosslinking agent is any one of bis(vinylphenyl) ethane (BVPE), divinylbenzene (DVB), divinylnaphthalene, divinylbiphenyl, triallyl isocyanurate (TAIC), triallyl cyanurate (TAC), vinylbenzocyclobutene (VBCB), bis(vinylbenzyl) ether (BVBE), trivinyl cyclohexane (TVCH), diallyl bisphenol A (DABPA), acrylate with two or more functional groups (such as but not limited to diallyl isophthalate (DAIP)), butadiene, decadiene, octadiene, or a combination thereof.

For example, in one embodiment, the resin composition of the present disclosure may also comprise any one of a benzoxazine resin, an epoxy resin, a polyester resin, a phenolic resin, an amine curing agent, a polyamide, a polyimide, a styrene maleic anhydride, a cyanate ester, a maleimide triazine resin or a combination thereof.

Unless otherwise specified, in the resin composition of the present disclosure, relative to 100 parts by weight of the free radical polymerizable resin, the amount of a benzoxazine resin, an epoxy resin, a polyester resin, a phenolic resin, a polyamide, a polyimide, a styrene maleic anhydride, a cyanate ester, or a maleimide triazine resin is not particularly limited and may be adjusted as needed, such as ranging from 1 part by weight to 100 parts by weight, such as but not limited to 1 part by weight, 10 parts by weight, 15 parts by weight, 20 parts by weight, 25 parts by weight, 50 parts by weight or 100 parts by weight. Relative to 100 parts by weight of the free radical polymerizable resin, the amount of an amine curing agent is also not particularly limited and may for example range from 1 to 15 parts by weight, such as but not limited to 1 part by weight, 4 parts by weight, 7.5 parts by weight, 12 parts by weight or 15 parts by weight.

According to the present disclosure, for example, the benzoxazine resin may be any benzoxazine resins known in the field to which this disclosure pertains. Examples include but are not limited to bisphenol A benzoxazine resin, bisphenol F benzoxazine resin, phenolphthalein benzoxazine resin, dicyclopentadiene benzoxazine resin, phosphorus-containing benzoxazine resin, diamino benzoxazine resin and phenyl group-modified, vinyl group-modified or allyl group-modified benzoxazine resin. Commercially available products include LZ-8270 (phenolphthalein benzoxazine resin), LZ-8298 (phenolphthalein benzoxazine resin), LZ-8280 (bisphenol F benzoxazine resin) and LZ-8290 (bisphenol A benzoxazine resin) available from Huntsman, and KZH-5031 (vinyl-modified benzoxazine resin) and KZH-5032 (phenyl-modified benzoxazine resin) available from Kolon Industries Inc. The diamino benzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin or a combination thereof, but not limited thereto.

According to the present disclosure, for example, the epoxy resin may be any epoxy resins known in the field to which this disclosure pertains. In terms of improving the heat resistance of the resin composition, the epoxy resin may include, but not limited to, any one of bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional novolac epoxy resin, dicyclopentadiene (DCPD) epoxy resin, phosphorus-containing epoxy resin, p-xylene epoxy resin, naphthalene epoxy resin (e.g., naphthol epoxy resin), benzofuran epoxy resin, isocyanate-modified epoxy resin, or a combination thereof. According to the present disclosure, for example, the novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. According to the present disclosure, for example, the phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be any one or more selected from DOPO-containing phenol novolac epoxy resin, DOPO-containing o-cresol novolac epoxy resin and DOPO-containing bisphenol-A novolac epoxy resin; the DOPO-HQ epoxy resin may be any one or more selected from DOPO-HQ-containing phenol novolac epoxy resin, DOPO-HQ-containing o-cresol novolac epoxy resin and DOPO-HQ-containing bisphenol-A novolac epoxy resin, but not limited thereto.

According to the present disclosure, for example, the polyester resin may be any polyester resins known in the field to which this disclosure pertains. Examples include but are not limited to a dicyclopentadiene-containing polyester resin and a naphthalene-containing polyester resin. Examples include, but not limited to, HPC-8000 or HPC-8150 available from D.I.C. Corporation.

According to the present disclosure, for example, the phenol resin may be any phenol resins known in the field to which this disclosure pertains. Examples include but are not limited to novolac resin or phenoxy resin, wherein the novolac resin includes phenol novolac resin, o-cresol novolac resin, bisphenol A novolac resin, naphthol novolac resin, biphenyl novolac resin, and dicyclopentadiene phenol resin, but not limited thereto.

According to the present disclosure, for example, the amine curing agent may be any amine curing agents known in the field to which this disclosure pertains. Examples include but are not limited to any one or a combination of diaminodiphenyl sulfone, diaminodiphenyl methane, diaminodiphenyl ether, diaminodiphenyl sulfide and dicyandiamide.

According to the present disclosure, for example, the polyamide may be any polyamides known in the field to which this disclosure pertains. Examples include but are not limited to various commercially available polyamide resin products.

According to the present disclosure, for example, the polyimide may be any polyimides known in the field to which this disclosure pertains. Examples include but are not limited to various commercially available polyimide resin products.

According to the present disclosure, for example, the styrene maleic anhydride may be any styrene maleic anhydride known in the field to which this disclosure pertains, wherein the molar ratio of styrene (St) to maleic anhydride (MA) may be 1/1, 2/1, 3/1, 4/1, 6/1, 8/1 or 12/1. Examples include but are not limited to styrene maleic anhydride copolymers such as SMA-1000, SMA-2000, SMA-3000, EF-30, EF-40, EF-60 and EF-80 available from Cray Valley, or styrene maleic anhydride copolymers such as C400, C500, C700 and C900 available from Polyscope.

According to the present disclosure, for example, the cyanate ester may be any cyanate ester resins known in the field to which this disclosure pertains, such as a compound having an Ar—O—C≡N structure, wherein Ar may be a substituted or unsubstituted aromatic group. In terms of improving the heat resistance of the resin composition, examples include but are not limited to novolac cyanate ester resin, bisphenol A cyanate ester resin, bisphenol F cyanate ester resin, dicyclopentadiene-containing cyanate ester resin, naphthalene-containing cyanate ester resin, phenolphthalein cyanate ester resin, adamantane cyanate ester resin, fluorene cyanate ester resin or a combination thereof. The novolac cyanate ester resin may be bisphenol A novolac cyanate ester resin, bisphenol F novolac cyanate ester resin or a combination thereof. For example, the cyanate ester resin may be available under the product name Primaset PT-15, PT-30S, PT-60S, BA-200, BA-230S, BA-3000S, BTP-2500, BTP-6020S, DT-4000, DT-7000, ULL950S, HTL-300, CE-320, LVT-50, or LeCy sold by Lonza.

According to the present disclosure, for example, the maleimide triazine resin may be any maleimide triazine resin known in the field to which this disclosure pertains. Examples include but are not limited to: the maleimide triazine resin obtained by polymerizing bisphenol A cyanate ester resin and maleimide resin, the maleimide triazine resin obtained by polymerizing bisphenol F cyanate ester resin and maleimide resin, the maleimide triazine resin obtained by polymerizing phenol novolac cyanate ester resin and maleimide resin and the maleimide triazine resin obtained by polymerizing dicyclopentadiene-containing cyanate ester resin and maleimide resin. In one embodiment, the maleimide triazine resin may be obtained by polymerizing the maleimide resin and the cyanate ester resin at any molar ratio; for example, the molar ratio of maleimide resin to cyanate ester resin may be from 1:1 to 1:10, such as but not limited to 1:1, 1:2, 1:4, 1:6, 1:8 or 1:10.

For example, in one embodiment, the resin composition of the present disclosure may also optionally comprise any one of a flame retardant different from the phosphorus-containing polymer disclosed herein, a curing accelerator, a polymerization inhibitor, an inorganic filler, a solvent, a silane coupling agent, a surfactant, a coloring agent, a toughening agent, or a combination thereof.

According to the present disclosure, for example, the flame retardant different from the phosphorus-containing polymer disclosed herein may be any one or more flame retardants different from the phosphorus-containing polymer disclosed herein suitable for preparing a prepreg, a resin film, a metal-clad laminate or a printed circuit board, such as but not limited to a phosphorus-containing flame retardant or a bromine-containing flame retardant different from the phosphorus-containing polymer disclosed herein. The bromine-containing flame retardant preferably comprises decabromodiphenyl ethane. The phosphorus-containing flame retardant different from the phosphorus-containing polymer disclosed herein may preferably include: hydroquinone bis-(diphenyl phosphate), bisphenol A bis-(diphenylphosphate), tri (2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), ammonium polyphosphate, melamine polyphosphate, phosphazene (such as commercially available SPB-100, SPH-100, and SPV-100), 9,10-dihydro-9-oxa-10-phosphaphenanthrene-10-oxide (DOPO) compound and its derivatives or resins (e.g., di-DOPO compound), diphenylphosphine oxide (DPPO) compound and its derivatives or resins (e.g., di-DPPO compound), melamine cyanurate, tri-hydroxy ethyl isocyanurate, aluminium phosphinate (e.g., commercially available OP-930 and OP-935), or a combination thereof.

For example, in one embodiment, the flame retardant different from the phosphorus-containing polymer disclosed herein may be a flame retardant commercially available from Katayama Chemical Industries Co., Ltd., such as but not limited to V1, V2, V3, V4, V5, V7, S-2, S-4, E-4c, E-7c, E-8g, E-9g, E-10g, E-100, B-3, W-10, W-2h, W-20, W-30, W-40, OX-1, OX-2, OX-4, OX-6, OX-6+, OX-7, OX-7+, OX-13, BPE-1, BPE-3, HyP-2, API-9, CMPO, ME-20, C-1R, C-1S, C-3R, C-3S or C-11R. The flame retardant different from the phosphorus-containing polymer disclosed herein may include one or more of the above flame retardants.

For example, in one embodiment, relative to 100 parts by weight of the free radical polymerizable resin, the resin composition of the present disclosure may further comprise 1 part by weight to 100 parts by weight of a flame retardant different from the phosphorus-containing polymer disclosed herein, preferably 5 parts by weight to 80 parts by weight of a flame retardant different from the phosphorus-containing polymer disclosed herein, but not limited thereto.

According to the present disclosure, for example, the curing accelerator may comprise a catalyst, such as a Lewis base or a Lewis acid. The Lewis base may comprise any one or more of imidazole, boron trifluoride-amine complex, ethyltriphenyl phosphonium chloride, 2-methylimidazole (2 MI), 2-phenyl-1H-imidazole (2PZ), 2-ethyl-4-methylimidazole (2E4MZ), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate. The curing accelerator also includes a curing initiator, such as a peroxide capable of producing free radicals. The curing initiator comprises but is not limited to: dicumyl peroxide (DCP), t-butyl peroxybenzoate, dibenzoyl peroxide (BPO), 2,5-dimethyl-2,5-di(t-butylperoxy)-3-hexyne (25B), 2,5-dimethyl-2,5-di-t-butyl peroxy-3-hexyne (DTBP), and bis(t-butylperoxyisopropyl)benzene or a combination thereof. For example, in one embodiment, relative to 100 parts by weight of the free radical polymerizable resin, the resin composition of the present disclosure may further comprise 0.001 part by weight to 2 parts by weight of a curing accelerator, preferably 0.01 part by weight to 1.5 parts by weight of a curing accelerator, more preferably 0.1 part by weight to 1.0 part by weight of a curing accelerator, but not limited thereto. Unless otherwise specified, all the various curing accelerators can be used in the polymerization reaction for preparing the phosphorus-containing polymer of the present disclosure.

According to the present disclosure, for example, the polymerization inhibitor may comprise, but not limited to, 1,1-diphenyl-2-picrylhydrazyl radical, methyl acrylonitrile, nitroxide-mediated radical, triphenylmethyl radical, metal ion radical, sulfur radical (such as including but not limited to dithioester), hydroquinone, 4-methoxyphenol, p-benzoquinone, phenothiazine, β-phenylnaphthylamine, 4-t-butylcatechol, methylene blue, 4,4′-butylidenebis(6-t-butyl-3-methylphenol) and 2,2′-methylenebis(4-ethyl-6-t-butylphenol) or a combination thereof. For example, the nitroxide-mediated radical may comprise, but not limited to, nitroxide radicals derived from cyclic hydroxylamines, such as 2,2,6,6-tetramethyl-1-oxo-piperidine, 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include but are not limited to 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like. For example, in one embodiment, relative to 100 parts by weight of the free radical polymerizable resin, the resin composition of the present disclosure may further comprise 0.001 part by weight to parts by weight of a polymerization inhibitor, preferably 0.001 part by weight to 10 parts by weight of a polymerization inhibitor, but not limited thereto.

According to the present disclosure, for example, the inorganic filler may be any one or more inorganic fillers suitable for preparing a prepreg, a resin film, a metal-clad laminate or a printed circuit board, examples thereof including but not limited to silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride, zirconium tungstate, petalite, calcined kaolin or a combination thereof. Moreover, the inorganic filler can be spherical (including solid sphere or hollow sphere), fibrous, plate-like, particulate, flake-like or whisker-like and can be optionally pretreated by a silane coupling agent. In addition, the color of the inorganic filler is not particularly limited and may be various colors such as white, black or light yellow, but not limited thereto. For example, in one embodiment, relative to 100 parts by weight of the free radical polymerizable resin, the resin composition of the present disclosure may further comprise 10 parts by weight to 300 parts by weight of an inorganic filler, preferably 80 parts by weight to 300 parts by weight of an inorganic filler, more preferably 100 parts by weight to 200 parts by weight of an inorganic filler, but not limited thereto.

According to the present disclosure, for example, the solvent may be any solvents suitable for dissolving the resin composition of the present disclosure, including but not limited to: methanol, ethanol, ethylene glycol monomethyl ether, acetone, butanone (methyl ethyl ketone), methyl isobutyl ketone, cyclohexanone, N-methyl-pyrrolidone, toluene, xylene, methoxyethyl acetate, ethoxyethyl acetate, propoxyethyl acetate, ethyl acetate, dimethylformamide, dimethylacetamide, propylene glycol monomethyl ether acetate, or a mixture thereof. The amount of solvent is determined in view of the purpose of completely dissolving the resin and adjusting to a certain total solid content of the resin composition. For example, in one embodiment, the amount of solvent is added to adjust the total solid content of the resin composition to 50% to 85%, but not limited thereto.

According to the present disclosure, for example, the silane coupling agent may comprise silane (such as but not limited to siloxane), which may be further categorized according to the functional groups into amino silane, epoxide silane, vinyl silane, hydroxyl silane, isocyanate silane, methacryloxy silane and acryloxy silane. For example, in one embodiment, relative to 100 parts by weight of the free radical polymerizable resin, the resin composition of the present disclosure may further comprise 0.001 part by weight to 20 parts by weight of a silane coupling agent, preferably 0.01 part by weight to 10 parts by weight of a silane coupling agent, but not limited thereto.

The type of the surfactant suitable for the resin composition of the present disclosure is not particularly limited. The purpose of surfactant used herein is to ensure uniform distribution of the filler in the resin composition. For example, in one embodiment, relative to 100 parts by weight of the free radical polymerizable resin, the resin composition of the present disclosure may further comprise 0.001 part by weight to parts by weight of a surfactant, preferably 0.01 part by weight to 5 parts by weight of a surfactant, but not limited thereto.

According to the present disclosure, for example, the coloring agent may comprise but is not limited to dye or pigment. For example, in one embodiment, relative to 100 parts by weight of the free radical polymerizable resin, the resin composition of the present disclosure may further comprise 0.001 part by weight to 10 parts by weight of a coloring agent, preferably 0.01 part by weight to 5 parts by weight of a coloring agent, but not limited thereto.

According to the present disclosure, the main purpose of adding a toughening agent is to improve the toughness of the resin composition. For example, the toughening agent suitable for the present disclosure may comprise, but not limited to, carboxyl-terminated butadiene acrylonitrile rubber (CTBN rubber), core-shell rubber, ethylene propylene rubber or a combination thereof. For example, in one embodiment, relative to 100 parts by weight of the free radical polymerizable resin, the resin composition of the present disclosure may further comprise 1 part by weight to 20 parts by weight of a toughening agent, preferably 3 parts by weight to 10 parts by weight of a toughening agent, but not limited thereto.

The present disclosure also provides an article made from the aforesaid resin composition, such as an article suitable for use as components in electronic products, including but not limited to a prepreg, a resin film, a metal-clad laminate or a printed circuit board.

For example, the resin composition of the present disclosure can be used to make a prepreg, which comprises a reinforcement material and a layered structure disposed thereon. The layered structure is formed by heating the resin composition at a high temperature to the semi-cured state (B-stage). Suitable baking temperature for making a prepreg may be for example 120° C. to 180° C., preferably 120° C. to 160° C. For example, the reinforcement material may be any one of a fiber material, woven fabric, and non-woven fabric, and the woven fabric preferably comprises fiberglass fabrics. The types of fiberglass fabrics are not particularly limited and may be any fiberglass fabric used for various printed circuit boards, such as E-glass fabric, D-glass fabric, S-glass fabric, T-glass fabric, L-glass fabric, Q-glass fabric or QL-glass fabric (glass fabric with hybrid structure made of Q-glass and L-glass); the fiber may comprise yarns and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the cured state (C-stage) to form an insulation layer.

For example, the resin composition of the disclosure can be used to make a resin film, which is prepared by heating and baking to semi-cure the resin composition. The resin composition may be selectively coated on a supporting material, which includes but is not limited to a liquid crystal polymer film, a polytetrafluoroethylene film, a polyethylene terephthalate film (PET film), a polyimide film (PI film), a metal foil (such as copper foil) or a resin-coated metal (such as resin-coated copper, RCC), followed by heating and baking to semi-cure the resin composition to form the resin film.

For example, the resin composition of the present disclosure may be made into a metal-clad laminate, which comprises at least two metal foils and at least one insulation layer disposed between the metal foils, wherein the insulation layer is made by curing the resin composition at high temperature and high pressure to the C-stage, a suitable curing temperature being for example between 190° C. and 220° C. and preferably between 200° C. and 210° C. and a suitable curing time being 90 to 180 minutes and preferably 120 to 150 minutes, a suitable lamination pressure being for example between 300 psi and 550 psi and preferably between 400 psi and 500 psi. The insulation layer may be obtained by curing the aforesaid prepreg or resin film. The metal foil may contain copper, aluminum, nickel, platinum, silver, gold or alloy thereof, such as copper. In a preferred embodiment, the metal-clad laminate is a copper-clad laminate.

In one embodiment, the metal-clad laminate may be further processed by trace formation processes to obtain a printed circuit board. In one embodiment of making the printed circuit board according to the present disclosure, a double-sided copper-clad laminate (such as product EM-827, available from Elite Electronic Material (Kunshan) Co., Ltd.) with a thickness of 28 mil and having 1-ounce HTE (high temperature elongation) copper foils may be used and subjected to drilling (drilling method such as but not limited to mechanical drilling and laser drilling) and then electroplating, so as to form electrical conduction through holes between the top layer copper foil and the bottom layer copper foil. Then the top layer copper foil and the bottom layer copper foil are etched to form an inner layer circuit. Then brown oxidation and roughening are performed on the inner layer circuits to form uneven structures on the surface to increase roughness, thereby forming the inner layer circuit board. Next, a vacuum lamination apparatus is used to laminate the assembly of a copper foil, the prepreg (or the resin film), the inner layer circuit board, the prepreg (or the resin film) and a copper foil stacked in said order by heating at 190° C. to 220° C. for 90 to 180 minutes to cure the insulation material in the semi-cured state. Next, black oxidation, drilling, copper plating and other known circuit board processes can be further performed on the outmost copper foils so as to obtain the printed circuit board.

For example, in one embodiment, an article made from the resin composition contains a reinforcement material or a supporting material and a semi-cured or cured product obtained by heating and chemically crosslinking the resin composition.

The present disclosure also provides a cured product made from the aforesaid resin composition. For example, in one embodiment, the cured product can be obtained by heating and chemically crosslinking the resin composition. In one embodiment, a cured product containing a supporting material can be obtained by coating the resin composition on the supporting material and then heating and chemically crosslinking to cure the resin composition. The supporting material comprises but is not limited to a liquid crystal polymer film, a polytetrafluoroethylene film (PTFE film), a polyethylene terephthalate film (PET film), a polyimide film (PI film) or a metal foil (preferably copper foil).

For example, in one embodiment, the present disclosure provides a cured product, comprising a cured product obtained by completely curing the resin composition through a heating process to the C-stage. In the heating process, a suitable curing temperature may be for example between 150° C. and 250° C., preferably between 190° C. and 220° C., and a curing time may be 90 to 240 minutes, preferably 120 to 180 minutes. For example, the shape of the cured product is not particularly limited and may be in the form of layers, blocks, particles, etc. For example, the preparation method of the cured product is not particularly limited, and the cured product may be obtained by placing the resin composition in a mold with specific shape and heating to completely cure the resin composition. The mold with specific shape includes but is not limited to a laminate with a groove, an electroplated hole of a printed circuit board or a circuit open area of a printed circuit board; it can also be obtained by coating the resin composition on a supporting material and heating to cure the resin composition completely.

For example, in one embodiment, the resin composition disclosed herein or various articles made therefrom may preferably have any one, more or all of the following properties:
a glass transition temperature as measured by reference to IPC-TM-650 2.4.24.4 of greater than or equal to 205° C., such as between 205° C. and 295° C. or between 210° C. and 295° C.;
a flame retardancy of V0 rating as measured by reference to UL94;
a dissipation factor as measured by reference to JIS C2565 of less than or equal to 0.00235, such as between 0.00129 and 0.00235;
a peeling strength as measured by reference to IPC-TM-650 2.4.8 of greater than or equal to 3.5 lb/in, such as between 3.5 lb/in and 4.5 lb/in or between 3.6 lb/in and 4.5 lb/in;
a percent of thermal expansion in Z-axis as measured by reference to IPC-TM-650 2.4.24.5 of less than or equal to 1.8%, such as between 0.5% and 1.8% or between 0.5% and 1.7%;
no delamination in a heat resistance test after moisture absorption as measured by reference to IPC-TM-650 2.6.16.1 and IPC-TM-650 2.4.23;
article appearance being absent from non-uniform resin flow; and
no delamination in a multi-layer board heat resistance test.

Raw materials below were used to prepare the resin compositions of various Examples and Comparative Examples of the present disclosure according to the amount listed in Table 1 to Table 5 and further fabricated to prepare test samples.

Materials and reagents used in Examples and Comparative Examples disclosed herein are listed below:
Phosphorus-containing polymer A1 to A10: prepared by the Applicant, as described in detail below.
Compound B1: copolymer of 4-(diphenylphosphino) styrene (DPPS), 4-vinylbenzocyclobutene (4-VBCB) and styrene (St), prepared by the Applicant, as described in detail below.
Compound B2: copolymer of 4-vinylbenzocyclobutene (4-VBCB) and styrene (St) (weight average molecular weight of approximately 3000 g/mol, St content of 56 wt %), prepared by the Applicant or commercially available.
Compound B3: copolymer of 4-(diphenylphosphino) styrene (DPPS) and styrene (St) (weight average molecular weight of approximately 3000 g/mol, DPPS content of 56 wt %, phosphorus content of 6.0 wt %), prepared by the Applicant or commercially available.
Compound B4: 4-(diphenylphosphino) styrene (DPPS) homopolymer (weight average molecular weight of approximately 3000 g/mol), prepared by the Applicant or commercially available.
Compound B5: 4-vinylbenzocyclobutene (4-VBCB) homopolymer (weight average molecular weight of approximately 3000 g/mol), prepared by the Applicant or commercially available.
Compound B6: 4-vinylbenzocyclobutene (4-VBCB) monomer, available from Chemtarget Technologies Co., Ltd.
SA9000: (meth)acryloyl group-containing polyphenylene ether resin, available from Sabic.
OPE-2st 1200: vinylbenzyl group-containing polyphenylene ether resin, available from Mitsubishi Gas Chemical Co., Inc.
OPE-2st 2200: vinylbenzyl group-containing polyphenylene ether resin, available from Mitsubishi Gas Chemical Co., Inc.
G1726: hydrogenated styrene-butadiene-styrene triblock copolymer, available from KRATON.
B-3000: polybutadiene, available from Nippon Soda Co., Ltd.
Ricon 100: styrene-butadiene copolymer, available from Cray Valley.
Ricon 184MA6: maleic anhydride-adducted styrene-butadiene copolymer, available from Cray Valley.
Divinylbenzene-styrene-ethylstyrene copolymer (DVB-St-EtSt): available from Nippon Steel Chemical & Material Co., Ltd.
BMI-5100:3,3′-dimethyl-5,5′-diethyl-4,4′-diphenylmethane bismaleimide, available from Daiwakasei Industry Co., Ltd.
BMI-2300: polyphenylmethane maleimide, available from Daiwakasei Industry Co., Ltd.
Maleimide resin of Formula (3-1): commercially available, as shown below.

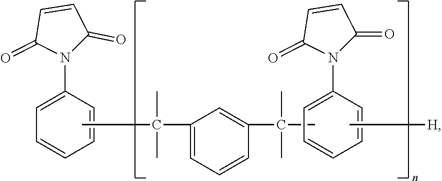

wherein n is an integer of 1 to 10.
Maleimide resin of Formula (3-2): commercially available, as shown below.

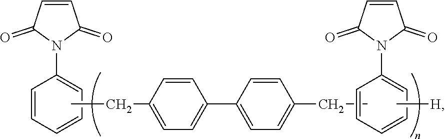

wherein n is an integer of 1 to 10.
Maleimide resin of Formula (3-3): commercially available, as shown below.

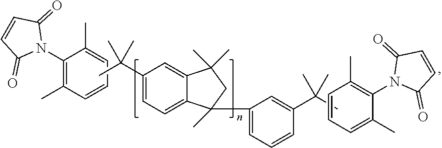

wherein n is a value from 0.95 to 10.
DVB: divinylbenzene, available from Shanghai Macklin Biochemical Co., Ltd.
BVPE: bis(vinylphenyl) ethane, available from Linchuan Chemical Co., Ltd.
TAIC: triallyl isocyanurate, available from Kingyorker Enterprise Co., Ltd.
25B: 2,5-dimethyl-2,5-di(t-butylperoxy)-3-hexyne, available from NOF Corporation.

Spherical silica: chemically synthesized spherical silica with surface treated by silane coupling agent, prepared by microemulsion, having a median particle size (D₅₀) of about 1.5±0.5 μm, commercially available.
Solvent: solvent mixture of toluene and methyl ethyl ketone (MEK) at a weight ratio of 1:1, wherein the toluene is available from Sinopec Group, and the methyl ethyl ketone is commercially available. The amount of solvent is shown as “PA” in the Tables to indicate a “proper amount” to represent an amount of solvent used to achieve a 60% to 68% total solid content (S/C═60% to 68%) of the resin composition.

### Preparation Example 1: Phosphorus-Containing Polymer A1

28 parts by mass of a first monomer 4-(diphenylphosphino) styrene (DPPS) was added into a three-necked flask. After heating and dissolving, 72 parts by mass of a second monomer 4-vinylbenzocyclobutene (4-VBCB) was added, followed by adding 1 part by mass of a curing accelerator 2,5-dimethyl-2,5-di-t-butylperoxy-3-hexyne (various curing accelerators listed above can also be used, and the reaction temperature and time may be adjusted as needed). Nitrogen gas was introduced to the reaction flask for 30 minutes to purge oxygen, and the reaction flask was kept sealed and heated to 130° C. for reacting 1 hour, followed by cooling to obtain the phosphorus-containing polymer A1 of Formula (P-1) (after calculation, the average number of repeating units x is about 0.15, and y is about 0.83), the phosphorus-containing polymer A1 having a weight average molecular weight of about 150 g/mol and a phosphorus content of about 3.0 wt %.

### Preparation Example 2: Phosphorus-Containing Polymer A2

The amount of the first monomer 4-(diphenylphosphino) styrene (DPPS) in Preparation Example 1 was adjusted to 56 parts by mass, the amount of the second monomer 4-vinylbenzocyclobutene (4-VBCB) was adjusted to 44 parts by mass, the reaction time was adjusted to 2 hours, and the other conditions were the same as Preparation Example 1, so as to obtain the phosphorus-containing polymer A2 of Formula (P-1) (after calculation, the average number of repeating units x is about 1.22, and y is about 2.13), the phosphorus-containing polymer A2 having a weight average molecular weight of about 630 g/mol and a phosphorus content of about 6.0 wt %.

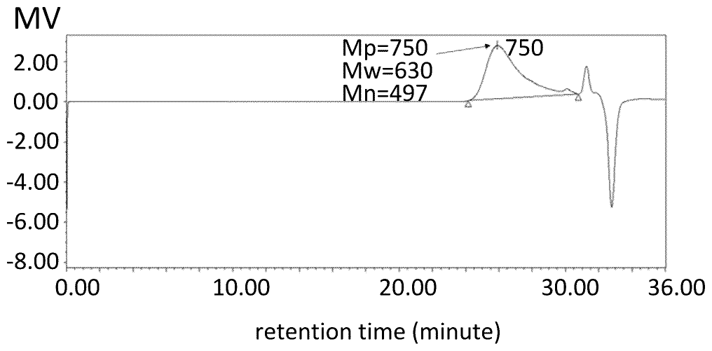

The molecular weight of the phosphorus-containing polymer A2 was analyzed by Waters 1515 gel permeation chromatograph (GPC). FIG. 1 illustrates the gel permeation chromatography (GPC) analysis results of the phosphorus-containing polymer A2. The ordinate (MV) represents the refractive index difference between sample and solvent, and the abscissa represents the retention time. According to the principle of gel permeation chromatography, the peaks of compounds show in order from large to small molecular weight. In FIG. 1, the distribution peak of molecular weight of the phosphorus-containing polymer A2 is located closer to Y-axis (shorter retention time), and the distribution peak of molecular weight of the monomer is located behind (longer retention time). In addition, the obtained phosphorus-containing polymer A2 has a wider distribution of molecular weight that contains multiple adjacent peaks. In contrast, the monomer has a narrower distribution of molecular weight that contains only one peak. FIG. 1 also shows that the weight average molecular weight (Mw) of the phosphorus-containing polymer A2 is about 630 g/mol, the number average molecular weight (Mn) is about 497 g/mol, and the peak molecular weight (Mp) is about 750 g/mol. According to the structures of the monomers, feed ratio and weight average molecular weight, the above average number of repeating units x and y and the phosphorus content can be obtained by calculation.

### Preparation Example 3: Phosphorus-Containing Polymer A3

The amount of the first monomer 4-(diphenylphosphino) styrene (DPPS) in Preparation Example 1 was adjusted to 74 parts by mass, the amount of the second monomer 4-vinylbenzocyclobutene (4-VBCB) was adjusted to 26 parts by mass, the reaction time was adjusted to 8 hours, and the other conditions were the same as Preparation Example 1, so as to obtain the phosphorus-containing polymer A3 of Formula (P-1) (after calculation, the average number of repeating units x is about 7.70, and y is about 5.99), the phosphorus-containing polymer A3 having a weight average molecular weight of about 3,000 g/mol and a phosphorus content of about 8.0 wt %.

### Preparation Example 4: Phosphorus-Containing Polymer A4

The amount of the first monomer 4-(diphenylphosphino) styrene (DPPS) in Preparation Example 1 was adjusted to 79 parts by mass, the amount of the second monomer 4-vinylbenzocyclobutene (4-VBCB) was adjusted to 21 parts by mass, the reaction time was adjusted to 6 hours, and the other conditions were the same as Preparation Example 1, so as to obtain the phosphorus-containing polymer A4 of Formula (P-1) (after calculation, the average number of repeating units x is about 8.22, and y is about 4.84), the phosphorus-containing polymer A4 having a weight average molecular weight of about 3,000 g/mol and a phosphorus content of about 8.5 wt %.

### Preparation Example 5: Phosphorus-Containing Polymer A5

The amount of the first monomer 4-(diphenylphosphino) styrene (DPPS) in Preparation Example 1 was adjusted to 20 parts by mass, the amount of the second monomer 4-vinylbenzocyclobutene (4-VBCB) was adjusted to 80 parts by mass, the reaction time was adjusted to 10 hours, and the other conditions were the same as Preparation Example 1, so as to obtain the phosphorus-containing polymer A5 of Formula (P-1) (after calculation, the average number of repeating units x is about 2.08, and y is about 18.43), the phosphorus-containing polymer A5 having a weight average molecular weight of about 3,000 g/mol and a phosphorus content of about 2.2 wt %.

### Preparation Example 6: Phosphorus-Containing Polymer A6

34 parts by mass of a first monomer of Formula (1.11) and dimethyl formamide (DMF) were added into a three-necked flask. After dissolving, 66 parts by mass of a second monomer of Formula (2.2) was added, followed by adding 1 part by mass of a curing accelerator 2,5-dimethyl-2,5-di-t-butylperoxy-3-hexyne (DTBP). Nitrogen gas was introduced to the reaction flask for 30 minutes to purge oxygen, and the reaction flask was kept sealed and heated to 130° C. for reacting 10 hours, followed by pouring the reaction solution into ethanol to precipitate, filtrate, wash, dry and purify, so as to obtain the phosphorus-containing polymer A6 of Formula (P-2) (after calculation, the average number of repeating units x is about 0.17, and y is about 0.69), the phosphorus-containing polymer A6 having a weight average molecular weight of about 150 g/mol and a phosphorus content of about 3.5 wt %.

### Preparation Example 7: Phosphorus-Containing Polymer A7

49 parts by mass of a first monomer of Formula (1.3) was added into a three-necked flask. After heating and dissolving, 51 parts by mass of a second monomer 4-vinylbenzocyclobutene (4-VBCB) was added, followed by adding 1 part by mass of a curing accelerator 2,5-dimethyl-2,5-di-t-butylperoxy-3-hexyne (DTBP). Nitrogen gas was introduced to the reaction flask for 30 minutes to purge oxygen, and the reaction flask was kept sealed and heated to 130° C. for reacting 20 hours, followed by cooling to obtain the phosphorus-containing polymer A7 of Formula (P-3) (after calculation, the average number of repeating units x is about 14.39, and y is about 39.17), the phosphorus-containing polymer A7 having a weight average molecular weight of about 10,000 g/mol and a phosphorus content of about 4.5 wt %.

### Preparation Example 8: Phosphorus-Containing Polymer A8

47 parts by mass of a first monomer 4-(diphenylphosphino) styrene (DPPS) was added into a three-necked flask. After heating and dissolving, 47 parts by mass of a second monomer 4-vinylbenzocyclobutene (4-VBCB) was added, followed by adding 6 parts by mass of butadiene (Bd) as a third monomer and 1 part by mass of a curing accelerator 2,5-dimethyl-2,5-di-t-butylperoxy-3-hexyne (DTBP). Nitrogen gas was introduced to the reaction flask for 30 minutes to purge oxygen, and the reaction flask was kept sealed and heated to 130° C. for reacting 5 hours, followed by cooling to obtain the phosphorus-containing polymer A8 of Formula (P-5) (after calculation, the average number of repeating units x is about 3.26, y is about 7.22, and z is about 2.22), the phosphorus-containing polymer A8 having a weight average molecular weight of about 2,000 g/mol and a phosphorus content of about 5.1 wt %.

### Preparation Example 9: Phosphorus-Containing Polymer A9

56 parts by mass of a first monomer 4-(diphenylphosphino) styrene (DPPS) was added into a three-necked flask. After heating and dissolving, 30 parts by mass of a second monomer 4-vinylbenzocyclobutene (4-VBCB) was added, followed by adding 14 parts by mass of divinylbenzene (DVB) as a third monomer and 1 part by mass of a curing accelerator 2,5-dimethyl-2,5-di-t-butylperoxy-3-hexyne (DTBP). Nitrogen gas was introduced to the reaction flask for 30 minutes to purge oxygen, and the reaction flask was kept sealed and heated to 130° C. for reacting 10 hours, followed by cooling to obtain the phosphorus-containing polymer A9 of Formula (P-6) (after calculation, the average number of repeating units x is about 9.71, y is about 11.52, and z is about 5.38), the phosphorus-containing polymer A9 having a weight average molecular weight of about 5,000 g/mol and a phosphorus content of about 6.0 wt %.

### Preparation Example 10: Phosphorus-Containing Polymer A10

65 parts by mass of a first monomer 4-(diphenylphosphino) styrene (DPPS) was added into a three-necked flask. After heating and dissolving, 20 parts by mass of a second monomer 4-vinylbenzocyclobutene (4-VBCB) was added, and 10 parts by mass of butadiene was added as a third monomer, followed by adding 5 parts by mass of 1,2-bis(4-vinylphenyl) ethane (BVPE) as a fourth monomer and 1 part by mass of a curing accelerator 2,5-dimethyl-2,5-di-t-butylperoxy-3-hexyne (DTBP). Nitrogen gas was introduced to the reaction flask for 30 minutes to purge oxygen, and the reaction flask was kept sealed and heated to 130° C. for reacting 15 hours, followed by cooling to obtain the phosphorus-containing polymer A10 of Formula (P-10) (after calculation, the average number of repeating units x is about 18.03, y is about 12.29, z is about 14.79, and w is about 1.71), the phosphorus-containing polymer A10 having a weight average molecular weight of about 8,000 g/mol and a phosphorus content of about 7.0 wt %.

### Preparation Example 11: Compound B1

39 parts by mass of a first monomer 4-(diphenylphosphino) styrene (DPPS) was added into a three-necked flask. After heating and dissolving, 18 parts by mass of a second monomer 4-vinylbenzocyclobutene (4-VBCB) was added, followed by adding 43 parts by mass of styrene as a third monomer and 1 part by mass of a curing accelerator 2,5-dimethyl-2,5-di-t-butylperoxy-3-hexyne (DTBP). Nitrogen gas was introduced to the reaction flask for 30 minutes to purge oxygen, and the reaction flask was kept sealed and heated to 130° C. for reacting 6 hours, followed by cooling to obtain the compound B1, which is the DPPS-VBCB-St phosphorus-containing terpolymer (after calculation, the average number of repeating units x is about 4.06, y is about 4.15, and z is about 12.39), the compound B1 having a weight average molecular weight of about 3,000 g/mol and a phosphorus content of about 4.2 wt %.

Compositions and test results of resin compositions of Examples and Comparative Examples used herein are listed in the tables below:

TABLE 1
Resin compositions of Examples and Comparative Example (in part by weight) and test results

| Component | | E1 | E2 | E3 | E4 | E5 | C1 |
|---|---|---|---|---|---|---|---|
| phosphorus- | A1 | | | | | | |
| containing | A2 | 50 | | | | | |
| polymer | A3 | | | | | | |
| | A4 | | | | | | |
| | A5 | | | | | | |
| | A6 | | | | | | |
| | A7 | | 50 | | | | |
| | A8 | | | 50 | | | |
| | A9 | | | | 50 | | |
| | A10 | | | | | 50 | |
| monomer or polymer | B1 | | | | | | 50 |
| different from | B2 | | | | | | |
| phosphorus- | B3 | | | | | | |
| containing | B4 | | | | | | |
| polymer | B5 | | | | | | |
| | B6 | | | | | | |
| unsaturated C═C | SA9000 | | | | | | |
| double bond- | OPE-2st 1200 | | | | | | |
| containing | OPE-2st 2200 | | | | | | |
| polyphenylene | | | | | | | |
| ether resin | | | | | | | |
| polyolefin | G1726 | | | | | | |
| | B-3000 | | | | | | |
| | Ricon 100 | | | | | | |
| | Ricon 184MA6 | | | | | | |
| | DVB-St-EtSt | | | | | | |
| maleimide resin | BMI-5100 | | | | | | |
| | BMI-2300 | | | | | | |
| | Formula (3-1) | | | | | | |
| | Formula (3-2) | | | | | | |
| | Formula (3-3) | | | | | | |
| unsaturated C═C | DVB | | | | | | |
| double bond- | BVPE | | | | | | |
| containing | TAIC | | | | | | |
| crosslinking agent | | | | | | | |
| curing accelerator | 25B | 0.8 | 0.8 | 0.8 | 0.8 | 0.8 | 0.8 |
| inorganic filler | spherical silica | | | | | | |
| solvent | toluene:MEK = 1:1 | PA | PA | PA | PA | PA | PA |
| Property | Unit | E1 | E2 | E3 | E4 | E5 | C1 |
| DMA-Tg | ° C. | 235 | 266 | 239 | 221 | 213 | 195 |
| flame retardancy | none | V0 | V0 | V0 | V0 | V0 | V0 |
| Df | none | 0.00132 | 0.00129 | 0.00129 | 0.00132 | 0.00136 | 0.00126 |

TABLE 2
Resin compositions of Examples (in part by weight) and test results

| Component | | E6 | E7 | E8 | E9 | E10 | E11 |
|---|---|---|---|---|---|---|---|
| phosphorus- | A1 | | | | | 50 | |
| containing | A2 | 50 | | 20 | 100 | | |
| polymer | A3 | | | | | | 50 |
| | A4 | | 12 | | | | |
| | A5 | | | | | | |
| | A6 | | | | | | |
| | A7 | | | | | | |
| | A8 | | | | | | |
| | A9 | | | | | | |
| | A10 | | | | | | |
| monomer or polymer | B1 | | | | | | |
| different from | B2 | | | | | | |
| phosphorus- | B3 | | | | | | |
| containing | B4 | | | | | | |
| polymer | B5 | | | | | | |
| | B6 | | | | | | |
| unsaturated C═C | SA9000 | 100 | 100 | 100 | 100 | 100 | 100 |
| double bond- | OPE-2st 1200 | | | | | | |
| containing | OPE-2st 2200 | | | | | | |
| polyphenylene | | | | | | | |
| ether resin | | | | | | | |
| polyolefin | G1726 | | | | | | |
| | B-3000 | | | | | | |
| | Ricon 100 | | | | | | |
| | Ricon 184MA6 | | | | | | |
| | DVB-St-EtSt | | | | | | |
| maleimide resin | BMI-5100 | | | | | | |
| | BMI-2300 | | | | | | |
| | Formula (3-1) | | | | | | |
| | Formula (3-2) | | | | | | |
| | Formula (3-3) | | | | | | |
| unsaturated C═C | DVB | | | | | | |
| double bond- | BVPE | | | | | | |
| containing | TAIC | | | | | | |
| crosslinking agent | | | | | | | |
| curing accelerator | 25B | 0.8 | 0.8 | 0.8 | 0.8 | 0.8 | 0.8 |
| inorganic filler | spherical silica | 120 | 120 | 120 | 120 | 120 | 120 |
| solvent | toluene:MEK = 1:1 | PA | PA | PA | PA | PA | PA |
| Property | Unit | E6 | E7 | E8 | E9 | E10 | E11 |
| DMA-Tg | ° C. | 215 | 205 | 210 | 220 | 226 | 210 |
| flame retardancy | none | V0 | V0 | V0 | V0 | V0 | V0 |
| Df | none | 0.00188 | 0.00194 | 0.00192 | 0.00184 | 0.00186 | 0.00190 |
| P/S | lb/in | 3.8 | 3.6 | 3.7 | 4.3 | 3.7 | 4.0 |
| Z-PTE | % | 1.4 | 1.8 | 1.4 | 1.3 | 1.1 | 1.4 |
| laminate appearance | none | OK | OK | OK | OK | OK | OK |
| heat resistance after | none | OOO | OOO | OOO | OOO | OOO | OOO |
| moisture absorption | | | | | | | |
| multi-layer board | none | OK | OK | OK | OK | OK | OK |
| heat resistance | | | | | | | |

TABLE 3
Resin compositions of Examples (in part by weight) and test results

| Component | | E12 | E13 | E14 | E15 | E16 | E17 |
|---|---|---|---|---|---|---|---|
| phosphorus- | A1 | | | | | | |
| containing | A2 | | | | | 80 | |
| polymer | A3 | | | | | | 60 |
| | A4 | 50 | | | | | |
| | A5 | | 100 | | | | |
| | A6 | | | | | | |
| | A7 | | | | 50 | | |
| | A8 | | | 60 | | | |
| | A9 | | | | | | |
| | A10 | | | | | | |
| monomer or polymer | B1 | | | | | | |
| different from | B2 | | | | | | |
| phosphorus- | B3 | | | | | | |
| containing | B4 | | | | | | |
| polymer | B5 | | | | | | |
| | B6 | | | | | | |
| unsaturated C═C | SA9000 | 100 | 100 | | | 50 | 50 |
| double bond- | OPE-2st 1200 | | | | | | |
| containing | OPE-2st 2200 | | | 100 | | | |
| polyphenylene | | | | | | | |
| ether resin | | | | | 100 | | |
| polyolefin | G1726 | | | | | | |
| | B-3000 | | | | | 50 | |
| | Ricon 100 | | | | | | |
| | Ricon 184MA6 | | | | | | |
| | DVB-St-EtSt | | | | | | 50 |
| maleimide resin | BMI-5100 | | | | | | |
| | BMI-2300 | | | | | | |
| | Formula (3-1) | | | | | | |
| | Formula (3-2) | | | | | | |
| | Formula (3-3) | | | | | | |
| unsaturated C═C | DVB | | | | | | |
| double bond- | BVPE | | | | | | |
| containing | TAIC | | | | | | |
| crosslinking agent | | | | | | | |
| curing accelerator | 25B | 0.8 | 0.8 | 0.8 | 0.8 | 0.8 | 0.8 |
| inorganic filler | spherical silica | 120 | 120 | 120 | 120 | 120 | 120 |
| solvent | toluene:MEK = 1:1 | PA | PA | PA | PA | PA | PA |
| Property | Unit | E12 | E13 | E14 | E15 | E16 | E17 |
| DMA-Tg | ° C. | 206 | 241 | 218 | 225 | 223 | 221 |
| flame retardancy | none | V0 | V0 | V0 | V0 | V0 | V0 |
| Df | none | 0.00190 | 0.00179 | 0.00206 | 0.00200 | 0.00168 | 0.00170 |
| P/S | lb/in | 4.1 | 3.5 | 4.0 | 3.9 | 3.7 | 3.8 |
| Z-PTE | % | 1.7 | 1.0 | 1.2 | 1.1 | 1.1 | 1.1 |
| laminate appearance | none | OK | OK | OK | OK | OK | OK |
| heat resistance after | none | OOO | OOO | OOO | OOO | OOO | OOO |
| moisture absorption | | | | | | | |
| multi-layer board heat | none | OK | OK | OK | OK | OK | OK |
| resistance | | | | | | | |

TABLE 4
Resin compositions of Examples (in part by weight) and test results

| Component | | E18 | E19 | E20 | E21 | E22 | E23 |
|---|---|---|---|---|---|---|---|
| phosphorus- | A1 | | | 80 | 20 | 20 | 10 |
| containing | A2 | | | | 20 | 10 | 10 |
| polymer | A3 | 35 | | | 20 | 20 | 10 |
| | A4 | | | | | | |
| | A5 | | | | | | |
| | A6 | | | | | | 10 |
| | A7 | | | | | 5 | |
| | A8 | | | | | | 10 |
| | A9 | | | | | | 10 |
| | A10 | | 30 | | | 5 | |
| monomer or polymer | B1 | | | | | | |
| different from | B2 | | | | | | |
| phosphorus- | B3 | | | | | | |
| containing | B4 | | | | | | |
| polymer | B5 | | | | | | |
| | B6 | | | | | | |
| unsaturated C═C | SA9000 | | | | 14 | 20 | 40 |
| double bond- | OPE-2st 1200 | | | | | | |
| containing | OPE-2st 2200 | | | | 6 | 5 | 10 |
| polyphenylene | | | | | | | |
| ether resin | | | | | 6 | 5 | 10 |
| polyolefin | G1726 | | | | 10 | 10 | 5 |
| | B-3000 | | | | 24 | 10 | 5 |
| | Ricon 100 | | | | 2 | | |
| | Ricon 184MA6 | | | | | 2 | |
| | DVB-St-EtSt | | | | 22 | 8 | 5 |
| maleimide resin | BMI-5100 | | | | 8 | 15 | 5 |
| | BMI-2300 | | | | | 10 | 5 |
| | Formula (3-1) | 100 | | | 8 | 10 | 5 |
| | Formula (3-2) | | 100 | | | 5 | |
| | Formula (3-3) | | | 100 | | | 10 |
| unsaturated C═C | DVB | | | | 9 | 5 | 5 |
| double bond- | BVPE | | | | | | |
| containing | TAIC | | | | 9 | 15 | 20 |
| crosslinking agent | | | | | | | 5 |
| curing accelerator | 25B | 0.8 | 0.8 | 0.8 | 0.8 | 0.1 | 3.0 |
| inorganic filler | spherical silica | 120 | 120 | 120 | 120 | 80 | 300 |
| solvent | toluene:MEK = 1:1 | PA | PA | PA | PA | PA | PA |
| Property | Unit | E18 | E19 | E20 | E21 | E22 | E23 |
| DMA-Tg | ° C. | 294 | 295 | 286 | 232 | 246 | 235 |
| flame retardancy | none | V0 | V0 | V0 | V0 | V0 | V0 |
| Df | none | 0.00212 | 0.00235 | 0.00189 | 0.00173 | 0.00191 | 0.00180 |
| P/S | lb/in | 4.4 | 4.5 | 4.5 | 4.2 | 4.4 | 3.9 |
| Z-PTE | % | 0.8 | 0.8 | 0.8 | 1.1 | 1.0 | 0.5 |
| laminate appearance | none | OK | OK | OK | OK | OK | OK |
| heat resistance after | none | OOO | OOO | OOO | OOO | OOO | OOO |
| moisture absorption | | | | | | | |
| multi-layer board | none | OK | OK | OK | OK | OK | OK |
| heat resistance | | | | | | | |

TABLE 5
Resin compositions of Comparative Examples (in part by weight) and test results

| Component | | C2 | C3 | C4 | C5 | C6 | C7 |
|---|---|---|---|---|---|---|---|
| phosphorus- | A1 | | | | | | |
| containing | A2 | | | | | | |
| polymer | A3 | | | | | | |
| | A4 | | | | | | |
| | A5 | | | | | | |
| | A6 | | | | | | |
| | A7 | | | | | | |
| | A8 | | | | | | |
| | A9 | | | | | | |
| | A10 | | | | | | |
| monomer or polymer | B1 | | 50 | | | | |
| different from | B2 | | | 50 | | | |
| phosphorus- | B3 | | | | 50 | | |
| containing | B4 | | | | | 28 | 28 |
| polymer | B5 | | | | | | 22 |
| | B6 | | | | | 22 | |
| unsaturated C═C | SA9000 | 100 | 100 | 100 | 100 | 100 | 100 |
| double bond- | OPE-2st 1200 | | | | | | |
| containing | OPE-2st 2200 | | | | | | |
| polyphenylene | | | | | | | |
| ether resin | | | | | | | |
| polyolefin | G1726 | | | | | | |
| | B-3000 | | | | | | |
| | Ricon 100 | | | | | | |
| | Ricon 184MA6 | | | | | | |
| | DVB-St-EtSt | | | | | | |
| maleimide resin | BMI-5100 | | | | | | |
| | BMI-2300 | | | | | | |
| | Formula (3-1) | | | | | | |
| | Formula (3-2) | | | | | | |
| | Formula (3-3) | | | | | | |
| unsaturated C═C | DVB | | | | | | |
| double bond- | BVPE | | | | | | |
| containing | TAIC | | | | | | |
| crosslinking agent | | | | | | | |
| curing accelerator | 25B | 0.8 | 0.8 | 0.8 | 0.8 | 0.8 | 0.8 |
| inorganic filler | spherical silica | 120 | 120 | 120 | 120 | 120 | 120 |
| solvent | toluene:MEK = 1:1 | PA | PA | PA | PA | PA | PA |
| Property | Unit | C2 | C3 | C4 | C5 | C6 | C7 |
| DMA-Tg | ° C. | 200 | 198 | 233 | 165 | 210 | 211 |
| flame retardancy | none | V1 | V0 | V1 | V0 | V0 | V0 |
| Df | none | 0.00194 | 0.00187 | 0.00182 | 0.00187 | 0.00190 | 0.00187 |
| P/S | lb/in | 2.5 | 3.1 | 2.5 | 3.1 | 3.1 | 2.8 |
| Z-PTE | % | 2.5 | 2.0 | 1.1 | 2.8 | 1.4 | 1.4 |
| laminate appearance | none | OK | OK | OK | OK | OK | OK |
| heat resistance after | none | XXX | XXX | OOO | XXX | XXX | XXX |
| moisture absorption | | | | | | | |
| multi-layer board heat | none | NG | NG | OK | NG | NG | NG |
| resistance | | | | | | | |

For the property tests of Examples and Comparative Examples disclosed herein, samples (specimens) were prepared as described below and tested under specified conditions below.
(1) Cured product: Resin composition from each of Examples E1 to E5 or Comparative Example C1 was individually well-mixed to form a varnish, which was maintained at 190° C. to 220° C. for 120 minutes to 180 minutes, and cured completely to obtain a cured product.
(2) Prepreg (PP): Resin composition from each of Examples E6 to E23 or Comparative Examples C2 to C7 was individually well-mixed to form a varnish, which was then loaded to an impregnation tank; a fiberglass fabric (e.g., 2116 or 1080 L-glass fiber fabric, all available from Asahi) was impregnated into the impregnation tank to adhere the resin composition onto the fiberglass fabric, followed by heating at 150° C. to 170° C. to the B-stage to obtain a prepreg. Prepregs made from the 1080 L-glass fiber fabrics have a resin content of about 70%, and prepregs made from the 2116 L-glass fiber fabrics have a resin content of about 55%.
(3) Copper-clad laminate (8-ply, formed by lamination of eight prepregs): Two 18 μm hyper very low profile (HVLP) copper foils and eight prepregs obtained from 2116 L-glass fiber fabrics impregnated with each of Examples E6 to E23 or Comparative Examples C2 to C7 were prepared, each prepreg having a resin content of about 55%. An HVLP copper foil, eight prepregs and an HVLP copper foil were superimposed in such order and then subjected to a vacuum condition for lamination at 420 psi and 200° C. for 2 hours to form each copper-clad laminate (8-ply).
(4) Copper-clad laminate (2-ply, formed by lamination of two prepregs): Two 18 μm hyper very low profile (HVLP) copper foils and two prepregs obtained from 1080 L-glass fiber fabrics impregnated with each of Examples E6 to E23 or Comparative Examples C2 to C7 were prepared and stacked in the order of one copper foil, two prepregs and one copper foil, followed by lamination under vacuum at 420 psi and 200° C. for 2 hours to form each copper-clad laminate (2-ply).
(5) Copper-free laminate (8-ply, formed by lamination of eight prepregs): Each aforesaid copper-clad laminate (8-ply) was etched to remove the copper foils on both sides to obtain a copper-free laminate (8-ply).
(6) Copper-free laminate (2-ply, formed by lamination of two prepregs): Each aforesaid copper-clad laminate (2-ply) was etched to remove the copper foils on both sides to obtain a copper-free laminate (2-ply).

For each sample, test items and test methods are described below.

### 1. Glass Transition Temperature (Tg)

The cured product or copper-free laminate (8-ply) sample was subjected to the measurement of glass transition temperature (in ° C.) by using a dynamic mechanical analyzer (DMA) by reference to IPC-TM-650 2.4.24.4. Temperature interval during the measurement was set at 50° C. to 400° C. with a temperature increase rate of 2° C./minute.

### 2. Flame Retardancy

The cured product or copper-free laminate (8-ply) sample was measured by reference to UL94, and the results of the flame retardancy test were represented by V0, V1, or V2, wherein V0 indicates a superior flame retardancy to V1, V1 indicates a superior flame retardancy to V2, and burnout of sample is the worst.

### 3. Dissipation Factor (Df)

The cured product or copper-free laminate (2-ply) sample was measured by using a microwave dielectrometer (available from AET Corp.) by reference to JIS C2565 at room temperature (about 25° C.) and under 10 GHz frequency to obtain the dissipation factor. Lower dissipation factor represents better dielectric properties of the sample. Under a 10 GHz frequency, for a Df value of less than 0.005, a difference in Df of greater than or equal to 0.0001 represents substantial difference in dissipation factor of different laminates (i.e., significant technical difficulty).

### 4. Peeling Strength (P/S)

The copper-clad laminate (8-ply) was cut into a rectangular sample with a width of 24 mm and a length of greater than 60 mm, which was etched to remove surface copper foil to leave a rectangular copper foil with a width of 3.18 mm and a length of greater than 60 mm to be tested by using a tensile strength tester by reference to IPC-TM-650 2.4.8 at room temperature (about 25° C.) to measure the force (lb/in) required to separate the copper foil from the insulation layer of the laminate.

### 5. Percent of Thermal Expansion in Z-Axis (Z-PTE)

The copper-free laminate (8-ply) sample was subjected to thermal mechanical analysis (TMA) by reference to IPC-TM-650 2.4.24.5. Each sample was heated from 50° C. to 260° C. at a heating rate of 10° C./minute and then subjected to the measurement of percent (%) of thermal expansion in Z-axis in a temperature range of 50° C. to 260° C.

### 6. Laminate Appearance

The copper-free laminate (8-ply) sample was subjected to visual inspection to determine whether non-uniform resin flow is present on its edges; absence of non-uniform resin flow on its edges (i.e., resin flows uniformly) is designated as “OK”, and presence of non-uniform resin flow (i.e., resin does not flow uniformly) on its edges is designated as “NG”.

7. Heat Resistance after Moisture Absorption

By reference to IPC-TM-650 2.6.16.1, the copper-free laminate (8-ply) sample was subjected to a pressure cooking test (PCT) for 5 hours of moisture absorption (at a temperature of 121° C. and a relative humidity of 100%), and then, by reference to IPC-TM-650 2.4.23, immersed into a 288° C. csolder bath for 20 seconds, removed and then inspected to determine the absence or presence of delamination. Each Example or Comparative Example was evaluated by testing three identical samples, and a designation of “X” was given to represent delamination in any sample, indicating interlayer separation or blistering of the insulation layers of the laminate; the absence of delamination (designation of “O”) represents no interlayer delamination or blistering in the insulation layers of the laminate. OOO represents no delamination in all three samples, XXX represents delamination in all three samples, OOX represents delamination in one sample and no delamination in two samples, and OXX represents delamination in two samples and no delamination in one sample.

### 8. Multi-Layer Board Heat Resistance

A prepreg (resin content of about 55%) prepared from a 2116 L-glass fiber fabric impregnated with each of Examples E6 to E23 or Comparative Examples C2 to C7 was superimposed on both sides with a piece of hyper very low profile copper foil (18 μm in thickness), followed by lamination and curing under vacuum at high temperature (200° C.) and high pressure (500 psi) for 2 hours to obtain a copper-clad core board. Then the copper-clad core board obtained above was etched to remove the copper foils on both sides so as to obtain a copper-free core board (5 mil in thickness). Three copper-free core boards were prepared as above. Next, two 18 μm HVLP copper foils and eight prepregs (resin content of about 70%) obtained from 1080 L-glass fiber fabrics impregnated with each of Examples E6 to E23 or Comparative Examples C2 to C7 were prepared and stacked in the order of one copper foil, two prepregs (obtained from 1080 L-glass fiber fabrics), one copper-free core board, two prepregs (obtained from 1080 L-glass fiber fabrics), one copper-free core board, two prepregs (obtained from 1080 L-glass fiber fabrics), one copper-free core board, two prepregs (obtained from 1080 L-glass fiber fabrics), and one copper foil, followed by lamination under vacuum at 500 psi and 200° C. for 2 hours to form an eight-layer copper-clad laminate. The eight-layer copper-clad laminate was then cut to form a 18 inch*16 inch rectangular sample, which was subjected to a circuit board drilling process to make a 20*25 array of through holes (500 through holes) with a diameter of 0.3 mm, the vertical distance of adjacent hole walls being in six designs including 0.25/0.3/0.35/0.4/0.5/0.7 mm, six designs being a group, and a total of 24 groups being on the entire board, i.e., 72,000 through holes. Then the hole walls were copper-plated, two adjacent groups at the edge of the board or in the board were picked as a sample, and three samples were used in the multi-layer board heat resistance test.

Each aforesaid sample for multi-layer board heat resistance test was horizontally placed on (i.e., in contact with) the solder bath of a 288° C. solder pot; during each test, one surface of the sample was placed on the solder bath for 10 seconds and then removed therefrom and cooled at room temperature for 30 seconds, which was recorded as one round, and the sample was subjected to 10 rounds of test without overturning. The sample after 10 rounds of solder floating was sectioned at the drilled area and observed with an optical microscope to determine the presence or absence of delamination. Three specimens were tested for each Example or Comparative Example; if no delamination was observed in all three samples, a designation of “OK” was given, and if delamination was observed in at least one of the three samples, a designation of “NG” was given. As used herein, delamination may refer to interlayer separation or blistering. Delamination may occur between any layers of a laminate. For example, interlayer separation between insulation layers is considered as delamination; for example, blistering or separation between a copper foil and an insulation layer is also considered as delamination.

The following observations can be made from the test results in Table 1 to Table 5.

From Examples E1 to E5, it can be found that the cured product of the resin composition disclosed herein may achieve improvements in one or more of the following properties including glass transition temperature, flame retardancy and dissipation factor.

From the comparison of Examples E1 to E5 and Comparative Example C1, it can be found that if the cured product contains the phosphorus-containing polymer of the present disclosure, it will achieve significant improvements in glass transition temperature.

From Examples E6 to E23, it can be found that an article made from the resin composition disclosed herein may achieve improvements in one or more of the following properties including glass transition temperature, flame retardancy, dissipation factor, peeling strength, percent of thermal expansion in Z-axis, laminate appearance, heat resistance after moisture absorption and multi-layer board heat resistance.

In Examples E6 to E23, the phosphorus-containing polymers (A4 and A5) in Examples E7, E12 and E13 have a phosphorus content outside the range of 3.0 wt % to 8.0 wt %, and the phosphorus-containing polymers of other examples have a phosphorus content within the range of 3.0 wt % to 8.0 wt %. When the phosphorus-containing polymer has a phosphorus content within the range of 3.0 wt % to 8.0 wt %, it can further achieve improvements at least in the property of glass transition temperature.

In Examples E6 to E23, relative to 100 parts by weight of the free radical polymerizable resin, the amount of the phosphorus-containing polymer in Example E7 is 12 parts by weight, and the amount of phosphorus-containing polymer in other examples is 20 parts by weight to 100 parts by weight. When the amount of the phosphorus-containing polymer is within the range of 20 parts by weight to 100 parts by weight, it can further achieve improvements at least in the property of percent of thermal expansion in Z-axis.

From the comparison of Examples E6 to E23 and Comparative Example C2, it can be found that an article containing the phosphorus-containing polymer of the present disclosure, in contrast to not containing the phosphorus-containing polymer of the present disclosure, may achieve significant improvements in the following properties including glass transition temperature, flame retardancy, peeling strength, percent of thermal expansion in Z-axis, heat resistance after moisture absorption and multi-layer board heat resistance.

From the comparison of Examples E6 to E23 and Comparative Examples C3 to C7, it can be found that an article containing the phosphorus-containing polymer of the present disclosure may achieve improvements in the following properties at the same time including glass transition temperature, flame retardancy, dissipation factor, peeling strength, percent of thermal expansion in Z-axis, laminate appearance, heat resistance after moisture absorption and multi-layer board heat resistance; while an article containing a monomer or a polymer different from the phosphorus-containing polymer of the present disclosure (compounds B1 to B6) significantly deteriorates at least two of the following properties including glass transition temperature, flame retardancy, dissipation factor, peeling strength, percent of thermal expansion in Z-axis, laminate appearance, heat resistance after moisture absorption and multi-layer board heat resistance.

The above detailed description and examples are merely illustrative in nature and are not intended to limit the embodiments of the subject matter or the applications and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description can provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A phosphorus-containing polymer, comprising a structural unit derived from a first monomer and a structural unit derived from a second monomer, the first monomer comprising a phosphorus-containing compound of Formula (1-1), a phosphorus-containing compound of Formula (1-2) or a combination thereof, and the second monomer comprising a compound of Formula (2), 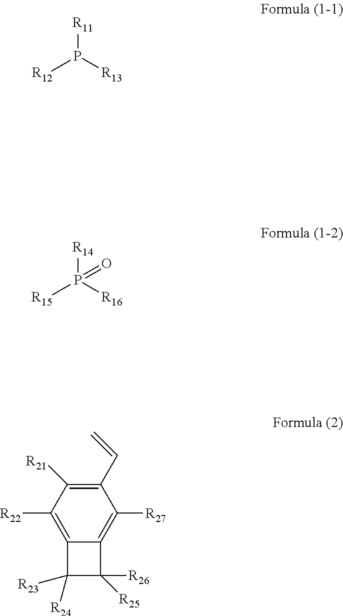
wherein:
in Formula (1-1), R₁₁ is a C2 to C4 alkenyl group or a C2 to C4 alkenyl group-substituted phenyl group, R₁₂ and R₁₃ each independently is a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group;
in Formula (1-2), R₁₄ is a C2 to C4 alkenyl group or a C2 to C4 alkenyl group-substituted phenyl group, R₁₅ and R₁₆ each independently is a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group;
in Formula (2), R₂₁ to R₂₇ each independently is a C1 to C3 hydrocarbyl group or a hydrogen atom; and
the phosphorus-containing polymer does not comprise a structural unit derived from styrene.

2. The phosphorus-containing polymer of claim 1, having a phosphorus content of between 2.2 wt % and 8.5 wt %.

3. The phosphorus-containing polymer of claim 1, having a phosphorus content of between 3.0 wt % and 8.0 wt %.

4. The phosphorus-containing polymer of claim 1, wherein the first monomer comprises a phosphorus-containing compound of any one of Formula (1.1) to Formula (1.12) or a combination thereof:

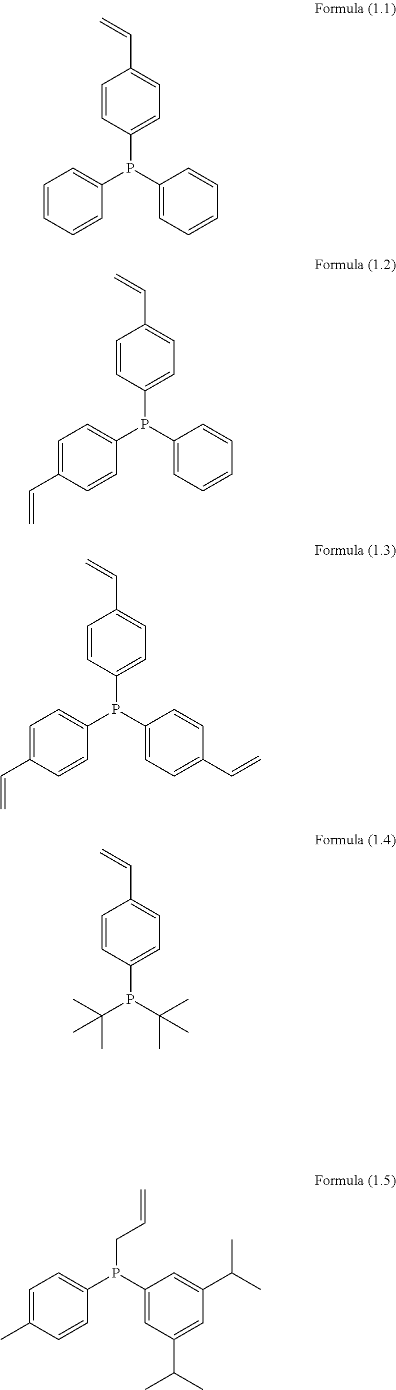

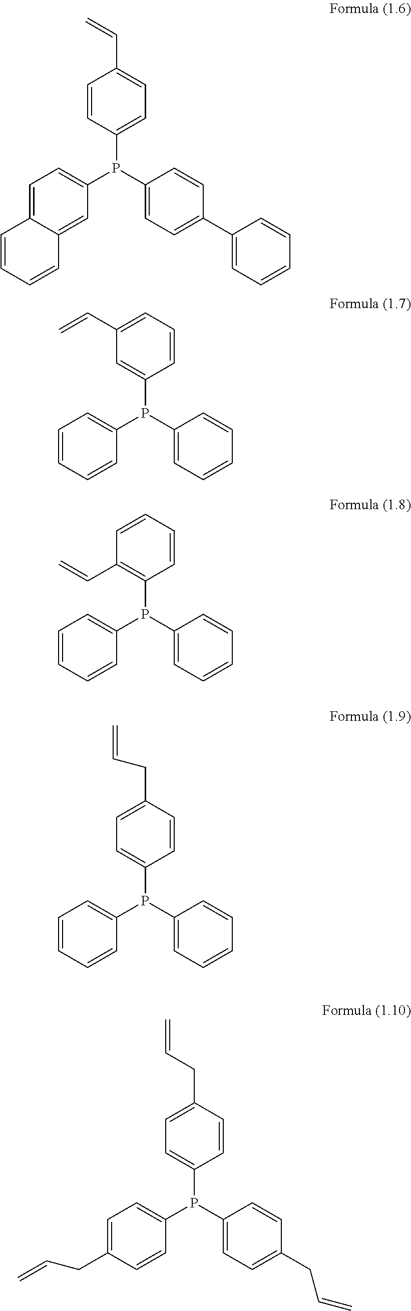 [SMILES: C=Cc1ccc(P(c2ccc(-c3ccccc3)cc2)c2ccc3ccccc3c2)cc1 ; C=Cc1cccc(P(c2ccccc2)c2ccccc2)c1 ; C=Cc1ccccc1P(c1ccccc1)c1ccccc1 ; C=CCc1ccc(P(c2ccccc2)c2ccccc2)cc1 ; C=CCc1ccc(P(c2ccc(CC=C)cc2)c2ccc(CC=C)cc2)cc1]

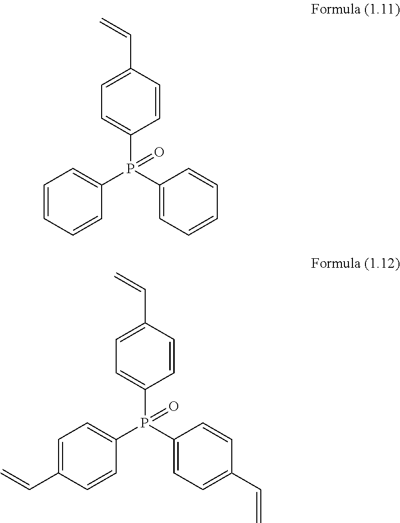 [SMILES: C=Cc1ccc(P(=O)(c2ccccc2)c2ccccc2)cc1 ; C=Cc1ccc(P(=O)(c2ccc(C=C)cc2)c2ccc(C=C)cc2)cc1]

5. The phosphorus-containing polymer of claim 1, wherein the second monomer comprises a compound of any one of Formula (2.1) to Formula (2.3) or a combination thereof:

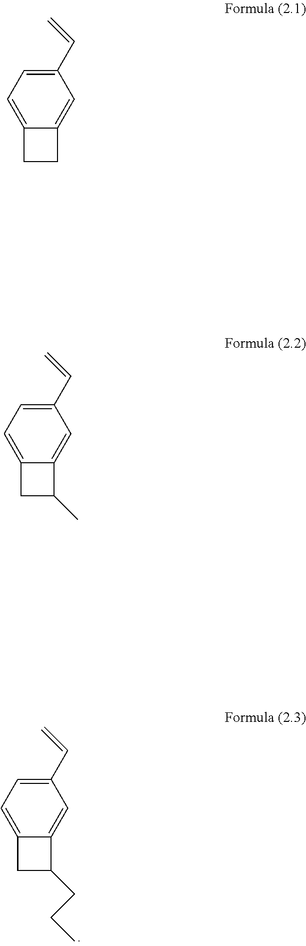

6. The phosphorus-containing polymer of claim 1, having a structure of any one of Formula (P-1) to Formula (P-14): 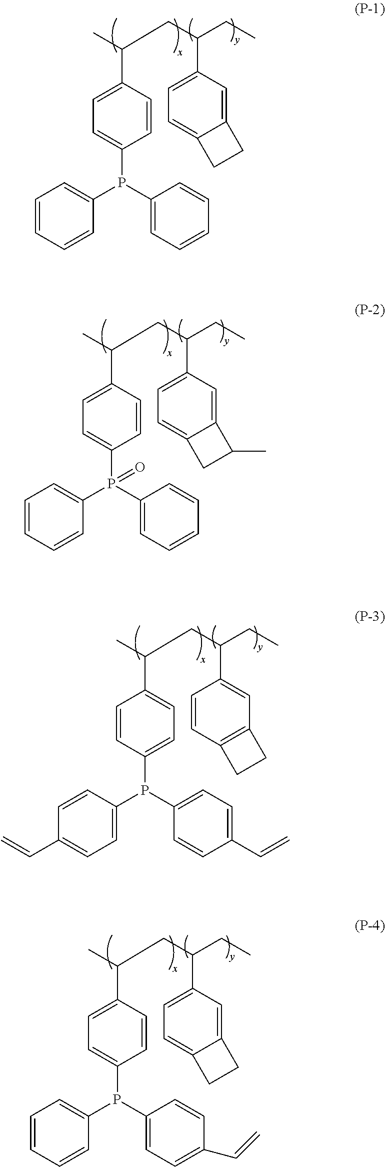 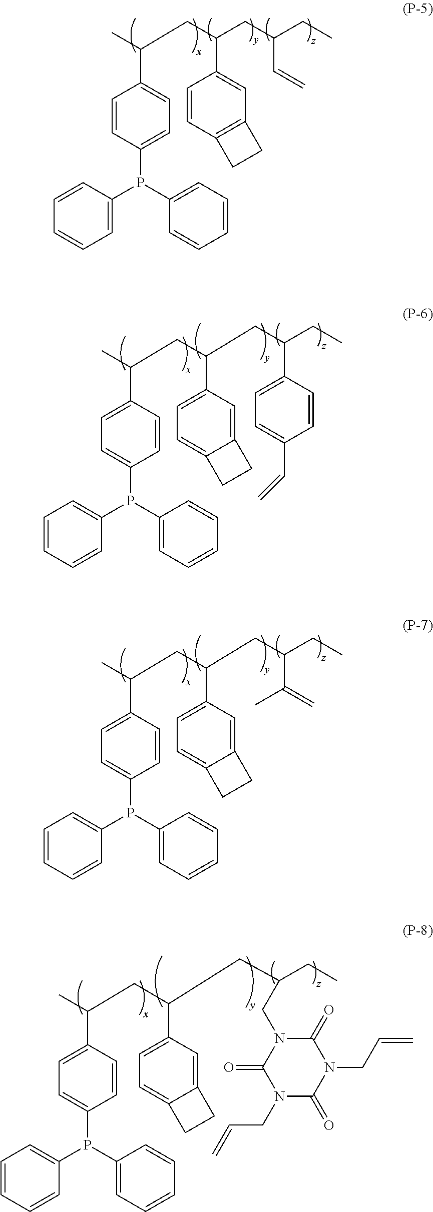 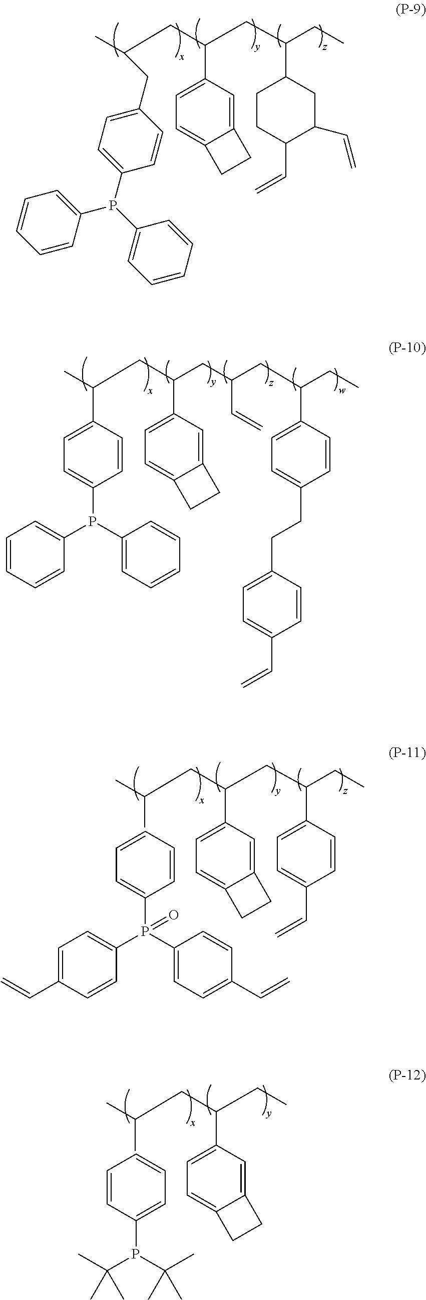 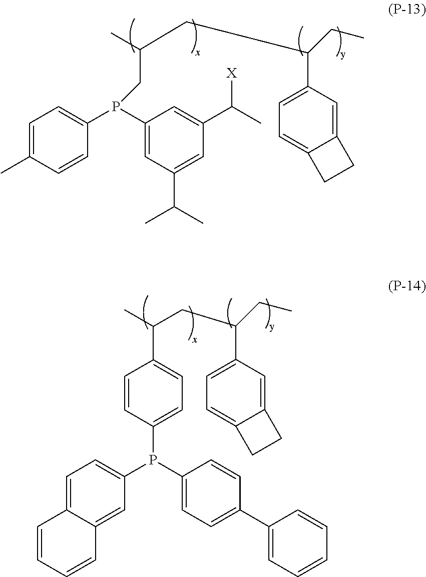
wherein x, y, z and w represent an average number of repeating units, and x is 0.10 to 28.00, y is 0.01 to 64.00, z is 0.01 to 27.00 and w is 0.01 to 5.00.

7. The phosphorus-containing polymer of claim 1, further comprising a structural unit derived from the following monomer: butadiene, isoprene, decadiene, octadiene, bis(vinylphenyl) ethane, divinylbenzene, divinylnaphthalene, divinylbiphenyl, triallyl isocyanurate, triallyl cyanurate, bis(vinylbenzyl) ether, trivinyl cyclohexane or a combination thereof.

8. A resin composition, comprising:
100 parts by weight of a free radical polymerizable resin, the free radical polymerizable resin comprising an unsaturated C═C double bond-containing polyphenylene ether resin, a maleimide resin, a polyolefin or a combination thereof; and
12 parts by weight to 100 parts by weight of the phosphorus-containing polymer of claim 1.

9. The resin composition of claim 8, comprising 20 parts by weight to 100 parts by weight of the phosphorus-containing polymer.

10. The resin composition of claim 8, further comprising an unsaturated C═C double bond-containing crosslinking agent, a benzoxazine resin, an epoxy resin, a polyester resin, a phenolic resin, an amine curing agent, a polyamide, a polyimide, a styrene maleic anhydride, a cyanate ester, a maleimide triazine resin or a combination thereof.

11. The resin composition of claim 8, further comprising a flame retardant different from the phosphorus-containing polymer, a curing accelerator, a polymerization inhibitor, an inorganic filler, a solvent, a silane coupling agent, a surfactant, a coloring agent, a toughening agent or a combination thereof.

12. An article made from the resin composition of claim 8, comprising a prepreg, a resin film, a metal-clad laminate or a printed circuit board.

13. An article made from the resin composition of claim 8, comprising a cured product obtained by curing the resin composition.

14. The article of claim 12, having a glass transition temperature as measured by reference to IPC-TM-650 2.4.24.4 of greater than or equal to 205° C.

15. The article of claim 12, having a flame retardancy of V0 rating as measured by reference to UL94.

16. The article of claim 12, having a dissipation factor as measured by reference to JIS C2565 of less than or equal to 0.00235.

17. The article of claim 12, having a peeling strength as measured by reference to IPC-TM-650 2.4.8 of greater than or equal to 3.5 lb/in.

18. The article of claim 12, having a percent of thermal expansion in Z-axis as measured by reference to IPC-TM-650 2.4.24.5 of less than or equal to 1.8%.

19. The article of claim 12, having no delamination in a heat resistance test after moisture absorption as measured by reference to IPC-TM-650 2.6.16.1 and IPC-TM-650 2.4.23.
